(19) United States
(12) Patent Application Publication
(10) Pub. No.: US 2005/0266222 A1
(43) Pub. Date: Dec. 1, 2005

(54) Fiber-reinforced composites and building structures comprising fiber-reinforced composites

(76) Inventors: Randy Jon Clark, Klamath Falls, OR (US); Rodney C. Harlin, Klamath Falls, OR (US); Craig R. Turner, Klamath Falls, OR (US); Gary L. Koepke, Klamath Falls, OR (US)

Correspondence Address: KILPATRICK STOCKTON LLP - 49942, 1001 WEST FOURTH STREET, WINSTON-SALEM, NC, 27101, US

(21) Appl. No.: 11/112,540

(22) Filed: Apr. 21, 2005

Related U.S. Application Data
(60) Provisional application No. 60/564,073, filed on Apr. 21, 2004.
(60) Provisional application No. 60/618,651, filed on Oct. 14, 2004.
(60) Provisional application No. 60/643,207, filed on Jan. 12, 2005.

(51) Int. Cl. B32B 17/04

(52) U.S. Cl. 428/292.1; 428/293.4; 428/295.1

(57) ABSTRACT

The present invention provides fiber-reinforced composites, and components for buildings, such as door skins, that include fiber-reinforced composites. Also provided are methods and systems for manufacturing fiber-reinforced composites that may be used in building structures. In an embodiment, the present invention provides a fiber-reinforced composite comprising long fibers of fiberglass and polyurethane produced using long-fiber injection (LFI) technology.

### STATEMENT OF RELATED APPLICATIONS

The present application claims priority under 35 USC 119(e) from U.S. provisional application Ser. No. 60/564,073, filed Apr. 21, 2004, entitled “Fiber-Reinforced Thermoset Polymer Composites and Methods and Systems for Making Same”, U.S. provisional application Ser. No. 60/618,651, filed Oct. 14, 2004, entitled “Fiber-Reinforced Polymer Composites and Methods and Systems for Making Same,” and from U.S. provisional application Ser. No. 60/643,207, filed Jan. 12, 2005, entitled “Fiber-Reinforced Polymer Composites.” The disclosure of each provisional is hereby incorporated herein by reference.

### FIELD OF THE INVENTION

The present invention relates to fiber-reinforced composites, their manufacture, and their use in building structures and the like.

### BACKGROUND

Doors, windows, wall panels, and other types of building structures have been manufactured from wood and other natural fiber-based materials for many years. Still, conventional wooden building structures such as doors, wall panels, and windows, while aesthetically pleasing, may suffer from some disadvantages. For example, solid wood doors can experience significant shrinking and swelling in response to extremes of temperature and humidity. Also, there is a tendency for doors and door frames to be bumped by objects being transported through the doorway. It may therefore be important to maintain the finish of natural wood doors and windows to preserve the integrity of the underlying structure. In addition, increased standards for fireproofing many structures have required replacement of wood doors with more fire-resistant materials.

Metal building structures, such as metal doors and windows, can provide an advantage over wooden doors in terms of relative cost and insulation efficiency. Still, metal building structures may dent or rust. Also, metal building structures may be limited in design. For example, it may be difficult to add three dimensional shaping, such as trim or paneling, to the outer surface of a metal door. In addition, the surface of a metal door is not particularly resistant to changes in temperature and thus, metal doors can become hot and cold to the touch in warm and cold environments, respectively. For these reasons, metal doors may not be as aesthetically pleasing as wooden doors.

### SUMMARY

The present invention provides fiber-reinforced composites. In an aspect, the fiber-reinforced composites comprise fibers and a polymer resin. The fiber-reinforced composites of the present invention may overcome the disadvantages set forth above, and may provide many additional advantages. The present invention also provides methods and systems for producing fiber-reinforced composites.

In another aspect, the present invention provides building structures comprising a fiber-reinforced composite of the present invention. A building structure comprises a component used in a building, such as a house, apartment building, office building, store, and/or other residential or commercial structures. Thus, as used herein, the term structure is a part, or a set of interconnected parts, of an item that comprises multiple parts. Building structures of the present invention include, but are not limited to, doors, door skins, structural panels for walls and doors (e.g., garage door panels), door frame parts, door and window parts (e.g., cladding for windows and door frames, plant-ons for doors), shingles, shutters, siding, and parts of such structures.

In a further aspect, the present invention provides methods for producing fiber-reinforced composites. In an additional aspect, the present invention provides systems for producing fiber-reinforced composites. In other aspects, the present invention provides methods and systems for producing building structures comprising fiber-reinforced composites of the present invention.

Advantages of the present invention include fiber-reinforced composites having improved thermal stability, improved flexibility and strength, reduced density, and reduced emission of volatile organic compounds (VOCs) during manufacturing.

Further details on each of these aspects of the present invention are set forth in the following description, figures and claims. It is to be understood that the invention is not limited in its application to the details set forth in the following description, figures and claims, but is capable of other embodiments and of being practiced or carried out in various ways.

### BRIEF DESCRIPTION OF THE FIGURES

FIG. 1 illustrates a door skin according to an embodiment of the present invention showing a perspective view as panel A, and a cross-sectional view of the outlined portion of the door skin as panel B.

FIG. 2, panels A-F, illustrate door skins in accordance with alternate embodiments of the present invention.

FIG. 3, panels A and B, illustrate additional door skins in accordance with alternate embodiments of the present invention; panel C illustrates a cross-sectional view of the outlined portion of the door skin shown in panel B.

FIG. 4, panels A-D, illustrate sidelights in accordance with alternate embodiments of the present invention.

FIG. 5 illustrates a panel for insertion of a glass pane into a door or sidelight, wherein panel A shows a perspective view and panel B shows a cross-sectional view in accordance with an embodiment of the present invention.

FIG. 6 illustrates a perspective view of a composite single car garage door in accordance with an embodiment of the present invention.

FIG. 7 illustrates a door frame in accordance with alternate embodiments of the present invention, where panel A illustrates an exploded view of partial door frame, showing partial cross-sections of a side door jamb, a header door jamb, and a bottom sill, and panel B illustrates a cross-sectional view of a side door jamb.

FIG. 8 shows additional fiber-reinforced composite building parts in accordance with alternate embodiments of the present invention, wherein panel A illustrates a siding part, panel B illustrates a shutter cover, panel C illustrates a window and component parts, and panel D illustrates a glass stop for a window.

FIG. 9 illustrates a flow diagram for the manufacture of a fiber-reinforced composite made by long fiber injection (“LFI”) in accordance with an embodiment of the present invention.

FIG. 10 shows a schematic representation of a system for the manufacture of a fiber-reinforced composite door skin in accordance with an embodiment of the present invention.

### DETAILED DESCRIPTION

For the purposes of this specification, unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

As set forth above, embodiments of the present invention include fiber-reinforced polymer composites, and methods and systems for making fiber-reinforced polymer composites. Embodiments of the present invention also include building structures comprising a fiber-reinforced composite of the present invention such as doors, door skins, structural panels for walls and doors (e.g., garage door panels), door frame parts, door and window parts (e.g., cladding for window parts, window frames, and door frames, plant-ons for doors), shingles, shutters, siding, and other building structures comprising fiber-reinforced polymer composites.

Examples of building structure embodiments of the present invention include door skins that are used to cover the frame of a door to provide the outer surface of the door. Such door skins may be only a few millimeters (mm) thick, but may have a surface area of several square feet or more. For example, a standard door skin for a single garage door panel may be about 24 inches (61 cm) wide by about 112 inches (284.5 cm) long and about ⅛ inch (3.2 mm) thick. Other examples of a thin-layer composite of the present invention include cladding that is used for building parts, such as cladding for door frame parts (e.g., jambs and headers) and window parts, molded siding (e.g., external siding designed to appear as wood), panels for doors and/or walls, and shingles. As used herein, a panel comprises a structure that is substantially thinner along one axis than the other two axes. A building structure of the present invention may comprise a single layer of a fiber-reinforced composite, although thin-layer composites may be used as part of a structure that has additional parts such as a frame, substrate or core.

In an embodiment, a fiber-reinforced composite of the present invention comprises a fiber and a polymer resin. The fiber component will generally comprise chopped or otherwise sectioned fiber strands, the composite thereby comprising a plurality of fiber pieces. In an embodiment, the fiber-reinforced composite of the present invention does not comprise fibers that have been arranged in an ordered structure. Thus, in an embodiment, the fiber of the fiber-reinforced composite comprises a plurality of chopped fibers arranged in a non-structured, substantially random orientation. For example, in an embodiment, the fibers in the composite are not purposefully interwoven with respect to each other in any one dimension. In an embodiment, the fiber-reinforced composite may be made using long-fiber injection (LFI) technology.

In another embodiment, the present invention comprises a fiber-reinforced composite building structure comprising a fiber and a polymer resin.

The polymer resin of the fiber-reinforced composite building structure may comprise a thermosetting polymer. In an embodiment, the thermosetting polymer may comprise a polyurethane.

The fibers used for the building structures of the present invention may comprise fiberglass. The fibers may range in length from about 5 mm to about 100 mm. In an embodiment, the fiber-reinforced composite building structures of the present invention do not comprise fibers that have been arranged in an ordered structure. Thus, in an embodiment, the fiber of the fiber-reinforced composite comprises a plurality of chopped fibers arranged in a non-structured, substantially random orientation. For example, in an embodiment, the fibers in the composite are not purposefully interwoven with respect to each other in any one dimension. In an embodiment, the fiber-reinforced composite building structure may be made using long-fiber injection (LFI) technology.

The fiber-reinforced composite building structures of the present invention may comprise other components, such as a catalyst, a blowing agent, or other additives. In one embodiment, the fiber-reinforced composite building structure may comprise a non-fiber filler. Alternatively or additionally, the fiber-reinforced composite building structure may comprise a coloring agent. In yet other embodiments, the fiber-reinforced composite building structure may comprise at least one of a release agent, a barrier coat, or an in-mold coating applied to at least a portion of the structure.

The present invention provides a variety of building structures comprising the fiber-reinforced composite of the present invention. In one embodiment, the building structure of the present invention comprises a substantially planar structure. For example, the fiber reinforced-composite building structure may comprise a door skin. Or, the building structure may comprise a door panel.

In another embodiment, the fiber-reinforced composite building structure of the present invention comprises a substantially non-planar surface. For example, in one embodiment, the fiber-reinforced composite building structure may comprise a cladding. In another embodiment, the building structure may comprise a door frame or a portion of a door frame. Or, the building structure may comprise a window frame or a portion of a window frame, or a window part, such as a sash, glass stop or a simulated divided light (SDL) bar (e.g., a muntin). In other alternative embodiments, the fiber-reinforced composite building structure of the present invention may comprise siding, a shutter, or a shingle.

In an embodiment, the present invention provides a fiber-reinforced composite door skin comprising a fiber and a polymer resin. The fiber-reinforced composite door skins of the present invention may be used as part of inside and outside passage doors, garage doors, patio doors, and other types of doors.

As with the other fiber-composite building structures of the present invention, the polymer resin of the fiber-reinforced composite door skin may comprise a thermosetting polymer. In an embodiment, the thermosetting polymer may comprise a polyurethane.

The fibers used for the door skins of the present invention may comprise fiberglass. In an embodiment, the fiber may range in length from about 5 mm to about 100 mm. In an embodiment, the fibers do not comprise fibers that have been arranged in an ordered structure. Thus, in an embodiment, the fiber of the fiber-reinforced composite door skin comprises a plurality of chopped fibers arranged in a non-structured, substantially random orientation. For example, in an embodiment, the fibers in the composite are not purposefully interwoven with respect to each other in any one dimension. In an embodiment, the fiber-reinforced composite door skin may be made using long-fiber injection (LFI) technology.

The fiber-reinforced composite door skins of the present invention may comprise other components such as a catalyst, a blowing agent and/or other additives. In one embodiment, the fiber-reinforced composite door skin may comprise a non-fiber filler. Alternatively or additionally, the fiber-reinforced composite door skin may comprise a coloring agent. In yet other embodiments, the fiber-reinforced composite door skin may comprise at least one of a release agent, a barrier coat, or an in-mold coating applied to at least a portion of the structure.

The door skin may be shaped as door skins traditionally used to make doors. For example, the door skin of the present invention may comprise an opening for a translucent panel, such as a window pane or the like. In one embodiment, the fiber-reinforced composite door skin of the present invention may comprise a substantially flat profile. As used herein, a substantially flat profile comprises a door skin that does not include protrusions or depressions on the surface of the door skin such as molding and other types of decorative shaping as discussed herein. In another embodiment, the door skin may comprise a molding. As used herein, a molding may comprise a shaping of the door skin surface as either a protrusion or a depression on the surface of the door skin. Such moldings may be placed on the door skin surface to provide the appearance of paneling and other decorative effects as discussed further herein. Also in an embodiment, the fiber-reinforced composite door skin of the present invention may comprise a substantially smooth surface. Alternatively or additionally, the fiber-reinforced composite door skin of the present invention may comprise a grain pattern on at least one surface.

In yet another embodiment, the present invention comprises a door comprising a fiber and a polymer resin formulated as a fiber-reinforced composite. As with the other fiber-composite building structures of the present invention, the polymer resin of the fiber-reinforced composite doors of the present invention may comprise a thermosetting polymer. In an embodiment, the thermosetting polymer may comprise a polyurethane.

The fibers used for the doors of the present invention may comprise fiberglass. The fiber may range in length from about 5 mm to about 100 mm. In one embodiment, the fiber-reinforced composite doors of the present invention do not comprise fibers that have been arranged in an ordered structure. Thus, in an embodiment, the fiber of the fiber-reinforced composite doors of the present invention may comprise a plurality of fibers arranged in a non-structured, substantially random orientation. For example, in an embodiment, the fibers in the composite are not purposefully interwoven with respect to each other in any one dimension. In an embodiment, the fiber-reinforced composite used in the door may be made using long-fiber injection (LFI) technology.

The fiber-reinforced composite doors of the present invention may comprise other components such as a catalyst, a blowing agent and/or other additives. In one embodiment, the fiber-reinforced composite may comprise a non-fiber filler. Alternatively or additionally, the fiber-reinforced composite of the doors of the present invention may comprise a coloring agent. In yet other embodiments, the fiber-reinforced composite of the door may comprise at least one of a release agent, a barrier coat, or an in-mold coating applied to at least a portion of the structure.

The fiber-reinforced composite door of the present invention may comprise a variety of structural components used in the manufacture of doors. In one embodiment, the fiber-reinforced composite may comprise a door skin. Alternatively or additionally, the fiber-reinforced composite may comprise a door panel. In yet another embodiment, the fiber-reinforced composite may comprise a plant-on structure or other type of applied molding used to provide trim or other design aspects for doors as described in more detail herein. In yet another embodiment, the fiber-reinforced composite may comprise cladding for a door.

The door of the present invention may comprise an opening for a translucent panel, such as a window pane or the like. Also, in an embodiment, the fiber-reinforced composite of the door may comprise a substantially smooth surface. Alternatively or additionally, the fiber-reinforced composite may comprise a grain pattern on at least one surface.

In another embodiment, the present invention comprises a method for producing a building structure. The method may comprise the step of preparing a mold having an internal volume in the shape a building structure. Also, the method may comprise the step of dispensing a mixture comprising a plurality of fibers and a polymer resin onto a surface of the mold. The method may also comprise the step of allowing the resin to polymerize under conditions sufficient to produce a fiber-reinforced composite. In an embodiment, the fiber-reinforced composite building structure may be made using long-fiber injection (LFI) technology.

In an embodiment, the polymer resin used in the method of the invention may comprise a thermosetting polymer. For example, the thermosetting polymer may comprise a polyurethane.

The fibers used in the methods of the present invention may comprise fiberglass. In an embodiment, the fiber may range in length from about 5 mm to about 100 mm. In an embodiment, the fibers do not comprise fibers that have been arranged in an ordered structure. Thus, in an embodiment, the fiber used in the methods of the present invention comprise a plurality of chopped fibers arranged in a non-structured, substantially random orientation. For example, in an embodiment, the fibers in the composite are not purposefully interwoven with respect to each other in any one dimension.

In an embodiment, other components are used in the method of making fiber-reinforced composite building structures of the present invention. In one embodiment, a filler may be added to form the fiber-reinforced composite building structure. Alternatively or additionally, a coloring agent may be added to form the fiber-reinforced composite. In yet other embodiments, at least one of a release agent, a barrier coat, or an in-mold coating applied to at least a portion of the structure.

For example, in some embodiments, a surface-active agent may be applied to either the mold, or to the composite, or to both. Thus, the method may comprise the step of applying a surface-active agent to at least a portion of the mixture injected onto the mold. For example, the surface agent applied to the mixture may comprise a release agent or a barrier coating. Alternatively or additionally, the method may comprise applying a surface-active agent to least one surface of the mold. For example, the surface agent applied to the mold may comprise a release agent, an in-mold coating, or a barrier coating.

The mold may be shaped as is required to form the building structure of interest. In one embodiment, the mold is shaped to form a substantially planar composite. For example, the mold may be shaped to form a door skin. Or, the mold may be shaped to form a door panel.

In other embodiments, the mold may be shaped to form a substantially non-planar structure. Thus, in alternate embodiments, the building structure of interest made by the methods of the present invention may comprise cladding, a door frame or a portion of a door frame, siding, a shutter, or a shingle. Or, the building structure may comprise a window frame or a portion of a window frame, or a window part, such as a sash, glass stop or a simulated divided light (SDL) bar (e.g., a muntin).

In one embodiment, the present invention comprises a method for producing a door skin. The method of producing a door skin may comprise the step of preparing a mold comprising a first and second die, where both dies comprise at least one substantially planar surface. The method may additionally comprise the step of dispensing a mixture comprising a plurality of fibers and a polymer resin onto the substantially planar surface of the first die. The method may additionally comprise the step of bringing the substantially planar surface of the second die in contact with the fibers and resin. Also, the method may comprise allowing the resin to polymerize under conditions sufficient to produce a fiber-reinforced composite in the shape of a door skin.

In an embodiment, the polymer resin used to make the door skin by the method of the invention may comprise a thermosetting polymer. For example, the thermosetting polymer may comprise a polyurethane.

The fibers used to make a door skin by the methods of the present invention may comprise fiberglass. In an embodiment, the fiber may range in length from about 5 mm to about 100 mm. In an embodiment, the fibers do not comprise fibers that have been arranged in an ordered structure. Thus, in an embodiment, the fiber used in the methods of the present invention comprises a plurality of chopped fibers arranged in a non-structured, substantially random orientation. For example, in an embodiment, the fibers in the composite are not purposefully interwoven with respect to each other in any one dimension. In one embodiment, the method of making door skins may comprise the use of long-fiber injection (LFI) technology.

In an embodiment, other components are used in the method of making fiber-reinforced composite door skins of the present invention. In one embodiment, a filler may be added to form the fiber-reinforced composite door skin. Alternatively or additionally, a coloring agent may be added to form the fiber-reinforced composite door skin. In yet other embodiments, the fiber-reinforced composite door skin may comprise at least one of a release agent, a barrier coat, or an in-mold coating applied to at least a portion of the door skin. For example, in some embodiments, a surface-active agent may be applied to either the mold, or to the composite, or to both. Thus, the method may comprise the step of applying a surface-active agent to at least a portion of the mixture dispensed onto the die. For example, the surface agent applied to the mixture may comprise a release agent or a barrier coating. Alternatively or additionally, the method may comprise applying a surface-active agent to least one surface of one of the dies. For example, the surface agent applied to the die may comprise a release agent, an in-mold coating, or a barrier coating.

The dies may be shaped to form a “flush” door skin, i.e., a door skin having an entire surface that is substantially flat. Thus, in one embodiment, at least one of the die surfaces in contact with the fibers and the polymer resin comprises a substantially flat surface such that the fiber-reinforced composite door skin comprises a flat profile. Alternatively or additionally, the dies may be shaped to form a door skin that comprises a protrusion or a depression on the surface of the door skin. Thus, in one embodiment, at least one of the die surfaces in contact with the fibers and the polymer resin comprises at least one of a groove or a protrusion such that the fiber-reinforced composite door skin comprises a molding. For example, in one embodiment, the first die may comprise a female die having a surface comprising at least one depression and the second die may comprise a male die comprising at least one protrusion, such that when the mold is closed, the depression and the protrusion are aligned with each other.

The dies may be shaped to form a door skin that has a smooth surface. As used herein, a smooth surface is a surface that is free from perceptible projections or roughness, or that does not include projections and depressions to simulate the appearance of a wood grain. Thus, in one embodiment, at least one of the die surfaces in contact with the fibers and polymer resin comprises a substantially smooth surface such that the fiber-reinforced composite door skin comprises at least one smooth surface. Alternatively or additionally, the dies may be shaped to form a door skin that has a grain pattern on at least one surface of the door skin. Thus, in an embodiment, at least one of the die surfaces in contact with the fibers and polymer resin comprises a grain pattern such that the fiber-reinforced composite door skin comprises at least one surface having a grain pattern.

The door skin may comprise a predefined thickness. Thus, the dies may be separated by a predetermined distance when the mold is closed. For example, in an embodiment, the predetermined distance ranges from 0.05 inches to 1.0 inch.

In yet another embodiment, the present invention comprise a system for manufacturing a building structure comprising an introducing apparatus and a mold shaped to form a building structure.

In an embodiment, the introducing apparatus may comprise a mixer for mixing at least two separate components required to form a polymer resin. The system may further include conduits for introducing the two separate resin components into the mixer. In addition, the system may include a means to add fiber to the building structure. In one embodiment, the system may comprise a chopper for chopping a plurality of fibers to a predetermined length.

Also, the system may comprise a dispenser for dispensing at least one of the plurality of fibers or the polymer resin onto a surface of the mold. In an embodiment, the fiber comprises a plurality of chopped fibers arranged in a non-structured, substantially random orientation. The fibers and polymer may be dispensed over the entire surface of the mold. Thus, in an embodiment, the system may comprise a robotic controller for positioning the dispenser at different positions relative to the mold. In an embodiment, the fibers and resin may be dispensed using long-fiber injection (LFI) technology. Also, a means to control the temperature of at least a portion of the mold may be included as part of the system.

In an embodiment, the polymer resin used in the system of the present invention may comprise a thermosetting polymer. For example, the thermosetting polymer may comprise a polyurethane.

The fibers used with the system of the present invention may comprise fiberglass. In an embodiment, the fiber may range in length from about 5 mm to about 100 mm. In an embodiment, the fibers do not comprise fibers that have been arranged in an ordered structure. For example, in an embodiment, the fibers in the composite are not purposefully interwoven with respect to each other in any one dimension.

In an embodiment, other components may be used in the system of the present invention. In one embodiment, a filler may be added to the resin and fiber mixture. Alternatively or additionally, a coloring agent may be added to the resin and fiber mixture.

In yet other embodiments, a release agent, a barrier coat, or an in-mold coating may be applied to at least a portion of the mold or to the fiber and resin mixture. For example, in some embodiments, a surface-active agent may be applied to either the mold, or to the composite, or to both. Thus, the system may comprise a surface-active agent that is applied to at least a portion of the mixture dispensed onto the die. For example, the surface agent applied to the mixture may comprise a release agent or a barrier coat. Alternatively or additionally, the system may comprise a surface-active agent that is applied to least one surface of one of the molds. For example, the surface agent applied to the mold may comprise a release agent, an in-mold coating, or a barrier coating.

The system may be used to make a variety of building structures. In an embodiment, the building structure comprises a substantially planar structure. For example, system may be used to make a fiber-reinforced composite door skin. Where the system is used to make a door skin, the mold may comprise two dies shaped to press a door skin. For example, the mold may comprise a first die and a second die, where each of the two dies comprise at least one substantially planar surface. In an embodiment, the first die may comprise a female die having a surface comprising at least one depression and the second die comprises a male die comprising at least one protrusion, such that when the mold is closed, the depression and the protrusion are aligned with each other to form a door skin comprise either a depression or a protrusion on at least one surface. Or, the die may be substantially flat to make flush door skins.

Alternatively or additionally, the dies may comprise a surface that is formulated to provide either a smooth surface or a grain pattern on at least one surface of the door skin. For example, at least a portion of at least one of the two dies may be polished to a smooth finish. Or, at least one of the two dies may comprise a pattern, such as a pattern to simulate wood grain, etched in the surface.

The door skin made using the systems of the present invention may comprise a predefined thickness. Thus, the dies may be separated by a predetermined distance when the mold is closed. For example, in an embodiment, the predetermined distance ranges from 0.05 inches (1.3 mm) to 1.0 inch (25.4 mm).

In another embodiment, the system may be used to form alternate building structures. Thus, in alternate embodiments, the building structure provided by the systems of the present invention may comprise a panel, cladding, a door frame or a portion of a door frame, siding, a shutter, or a shingle. Or, the building structure may comprise a window frame or a portion of a window frame, or a window part, such as a sash, glass stop or a simulated divided light (SDL) bar (e.g., a muntin).

Thus, the present invention comprises fiber-reinforced composites and building structures that comprise such fiber-reinforced composites. The fiber component of the fiber-reinforced composite may comprise a single fiber type or a plurality of fiber types. The fiber may comprise a natural or a manmade fiber. Suitable fibers include, but are not limited to, glass fibers, mineral fibers, natural fibers such as wood, flax, jute, or sisal fibers, and/or synthetic fibers, such as polyamide fibers, polyester fibers, carbon fibers or polyurethane fibers. In an embodiment, the fibers are fiberglass. In an embodiment, the fiberglass comprises Electronic glass (or E-glass).

In an embodiment, the fibers used in the fiber-reinforced composite of the present invention may have a length of greater than 1 millimeter (mm) (0.04 inch). In alternate embodiments, the fibers may have a length in the range of about 5 mm to 100 mm (0.2 to 3.9 inches). In alternate embodiments, the fibers may range in length from about 10 mm to 70 mm (0.4 to 2.8 inches), or from 30 mm to 50 mm (1.2 to 2.0 inches).

The resin component of a fiber-reinforced polymer composite of the present invention may comprise a thermosetting polymer resin. In an embodiment, the resin may comprise polyurethane. Alternatively and/or additionally, phenol formaldehyde, resorcinol formaldehyde, cross-linked polyesters, or other thermoset polymers may be used.

In an embodiment, the resin may be polyurethane. In some embodiments, polyurethanes may be made by reacting an isocyanate with an isocyanate-reactive compound such as a polyol, an amines, and/or water. In other embodiments, polyurethanes may be synthesized using mixtures of diamines and diols. In further embodiments, polyurethanes may be synthesized using mixtures of diamines.

In their non-reacted state, reagents for synthesizing polyurethanes are low viscosity liquids. When the liquids are mixed at the required ratio, an exothermic thermoset reaction occurs, creating a polyurethane material. Thus, a polyurethane may comprise a polyisocyanate polyadduct obtainable, for example, by reacting a polyisocyanate with an isocyanate-reactive polyol or amine in the presence or absence of other components such as, but not limited to, a catalyst, a blowing agent, or other additives.

The isocyanates may comprise (cyclo)aliphatic and/or aromatic polyisocyanates known in the art. In one embodiment, suitable isocyanates for preparing the composites of the invention may comprise aromatic diisocyanates, such as, but not limited to, diphenylmethane diisocyanate (“MDI”) and toluene diisocyanate (“TDI”), such as 2,4-touluene diisocyanate and 2,6-toluene diisocyanate. In some embodiments, aromatic diisocyanates may comprise naphthalene 1,5-diisocyanate.

Suitable isocyanate-reactive compounds may include compounds that comprise two or more reactive groups selected from OH, SH, NH, NH₂ and CH-acidic groups, such as β-diketo groups. See e.g., U.S. Patent Publication Nos. 2002/0160204 and 2004/0034113 for descriptions of example isocyanate-reactive compounds. The entire disclosure of these applications is incorporated herein by reference.

Examples of compounds that may be used to form polyurethanes include polyether-polyamines and/or polyols selected from the group of polyether polyols, polyester polyols, polythioether polyols, polyesteramides, hydroxyl-containing polyacetals, and hydroxyl-containing aliphatic polycarbonates, or mixtures of at least two of these polyols. In an embodiment, polyester polyols and/or polyether polyols may be used. In an embodiment, polyether polyols containing at least 10% primary hydroxyl groups may be used.

In some embodiments, diols may be utilized in the synthesis of polyurethanes. Diols may comprise, for example, ethylene glycol, 1,4-butanediol, 1,6 hexanediol, and/or p-di(2-hydroxyethoxy)benzene. In some embodiments, diamines including diethyltoluene-diamine, methylenebis(p-aminobenzene), and/or 3,3′-dichloro-4-4′-diaminophenyl-methane, for example, may utilized in the synthesis of polyurethanes.

Additionally, in some embodiments, polyurethanes may comprise any desired degree of crosslinking. In some embodiments, for example, isocyanates may react with urethane groups of different polyurethane chains to form allophanate crosslinks. In other embodiments, isocyanates may react with urea groups from different polyurethane chains to form biuret crosslinks. In some embodiments, isocyanates may react with urethane groups on a first polyurethane chain and urea groups on a second polyurethane chain to produce both allophanate and biuret crosslinks. Isocyanates, in some embodiments, may trimerize to form isocyanurates, which may serve as a source of crosslinking in polyurethanes.

In some embodiments, a blowing agent may be used in the fiber-reinforced composite of the present invention. As used herein, blowing agents comprise compounds that are commonly known to produce foamed products. In an embodiment, the blowing agent may comprise water. Other examples of physical blowing agents are inert (cyclo)aliphatic hydrocarbons having from 4 to 8 carbon atoms which may evaporate under the conditions of polymer formation, carbon dioxide, sodium bisulfite, or other compounds that may form gaseous bubbles under the conditions of polymerization. The amount of blowing agent used is guided by the target density of the foams.

Any number of catalysts customarily used to form the polymer resin may be used to make the fiber-reinforced composite of the present invention. For polyurethane, suitable catalysts may include tertiary amines and/or organometallic compounds. Examples of compounds which may be used as catalysts for polyurethane formation include the following: triethylenediamine, aminoalkyl- and/or aminophenyl-imidazoles, e.g., 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole; tin(II) salts of organic carboxylic acids, examples being tin(II) diacetate, tin(II) dioctoate, tin(II) diethylhexoate, and tin(II) dilaurate; and dialkyltin(IV) salts of organic carboxylic acids, examples being dibutyltin diacetate, dibutyltin dilaurate, dibutyltin maleate, and dioctyltin diacetate.

Also, and as described in more detail herein, the reaction may include additional components, such as cell regulators; surface-active compounds such as release agents, barrier coats, and/or other types of coatings; pigments or other colorants; fire retardants; or stabilizers to counter oxidative, thermal, moisture-based, or microbial degradation or aging.

In an embodiment, a fiber-reinforced composite of the present invention may comprise a filler. The filler may be sized or un-sized. The filler may be modified to have improved free-flow properties and adhesion to the polyurethane matrix. For example, the filler may comprise platelet-shaped fillers such as glass flakes and/or minerals such as mica.

In an embodiment, the fiber-reinforced composite of the present invention comprises long fiber-reinforced polyurethane. Long fiber-reinforced polyurethane may comprise the advantage of providing improved thermal stability and strength as compared to other types of fiber-reinforced polymers such as short fiber-reinforced polyurethane, sheet molding compound (“SMC”), or bulk molding compound (“BMC”). Where long fibers are used, the composite may be made by long-fiber injection (“LFI”) or long-fiber technology (“LFT”) processes or methods. Long fibers may include fibers having the dimensions described above.

Various amounts of the fiber and if needed, the filler, may be used in the fiber-reinforced composites of the present invention. In an embodiment, a fiber-reinforced composite of the present invention may comprise from greater than 0% to 90% by weight fiber; and from 0% to 33%, by weight filler, with the remainder being resin. In an alternate embodiment, the fiber-reinforced composite may comprise from 1 to 60% by weight fiber; and from 0 to 15%, by weight filler, with the remainder being resin. In another alternate embodiment, the fiber-reinforced composite may comprise from 20 to 50% by weight fiber; and from 0 to 10%, by weight filler, with the remainder being resin. In yet a further embodiment the fiber-reinforced composite may comprise from 30 to 45% by weight fiber; and from 0 to 6% by weight filler.

One advantage of using thermoset resins such as polyurethane in an embodiment of the present invention, is the reduced levels of Volatile Organic Compounds (“VOCs”) that are emitted during manufacture as compared to other resins such as polyester and the like. Polyurethane components are not diluted in solvent and are styrene-free and thus, emission of VOCs is essentially eliminated. In an embodiment, the fiber-reinforced polymer composites of the present invention comprise a VOC emission of less than 0.1 ppm. In another embodiment, the fiber-reinforced composites of the present invention comprise a VOC emission of less than 0.05 ppm. In yet another embodiment, the fiber-reinforced polymer composites of the present invention comprise a VOC emission of less than 0.01 ppm.

A fiber-reinforced composite of the present invention may be made having a density that is less than other fiberglass composites previously manufactured for use in building structures. For example, the fiber-reinforced composites of the present invention may have a density less than that of Sheet Molding Compound (“SMC”) fiberglass composites. In an embodiment, a fiber-reinforced composite of the present invention has a density in the range of about 12 pounds per cubic foot (pcf) to 110 pcf (about 192 to 1762 kilograms per cubic meter (kg/m³)). In an embodiment where the structure comprises a thin-layer structure such as a door skin, panel, or cladding, a fiber-reinforced composite of the present invention may comprise a density in the range of about 20 pounds per cubic foot (pcf) to 110 pcf (about 320 to 1762 kilograms per cubic meter (kg/m³)). In another embodiment, a fiber-reinforced composite may comprise a density of from about 30 pcf to 100 pcf (about 481 to 1602 kg/m³) or alternatively, from 35 pcf to 95 pcf (about 561 to 1522 kg/m³).

The fiber-reinforced composite of the present invention may have a linear thermal expansion that is sufficiently low to reduce swelling and/or shrinking upon exposure to extremes of temperature (temperatures above 82° C. or below −40° C.) such that the performance or appearance of the composite is improved. For example, in an embodiment, a fiber-reinforced composite may be substantially warp free upon exposure to temperatures above 82° C. or below −40° C., that could be reached during shipment, storage or use.

As used herein, linear thermal expansion is the change in length (dL) of an object in response to a change in temperature (dT). Linear expansion may be expressed as dL/L=a*dT, with the linear expansion coefficient (“a”) generally being of the order of magnitude of about 10⁻⁶/degrees Celsius (“° C.”). Linear expansion may be determined using ASTM Test Procedure D696-98 or its equivalent. In an embodiment, the linear thermal expansion coefficient of the fiber-reinforced composites of the present invention may range from 0.1×10⁻⁶/° C. to 140×10⁻⁶/° C. In an embodiment, for a thin-layer fiber reinforced composite of the present invention, the linear thermal expansion coefficient of the fiber-reinforced composite of the present invention may range from about 0.1×10⁻⁶/° C. to 50×10⁻⁶/° C. In other embodiments, the linear expansion coefficient may range from about 0.5×10⁻⁶/° C. to 25×10⁻⁶/° C., or alternatively from about 1×10⁻⁶/° C. to 15×10⁻⁶/° C.

For certain uses of a fiber-reinforced composite of the present invention, flexibility may be advantageous. In an embodiment, a fiber-reinforced composite of the present invention may comprise a modulus of elasticity under compression in the range of about 10,000 to 900,000 pounds per square inch (psi) (about 703 to about 63,276 kilograms per square centimeter (kg/cm²)). In an embodiment, a thin-layer fiber-reinforced composite of the present invention may be more flexible than fiber-reinforced polymer composites made using SMC technology. For example, in an embodiment, a fiber-reinforced composite of the present invention may comprise a modulus of elasticity under compression in the range of about 100,000 to 600,000 psi (about 7,032 to about 42,194 kg/cm²). The modulus of elasticity may be determined using ASTM Test Method D-638-02, or its equivalent.

The thickness of a fiber-reinforced composite of the present invention may depend on its intended application. The thickness may be substantially uniform, or may vary across the composite. The thickness may thus range from less than 0.02 inches thick to greater than 8 inches thick (0.5 mm to 20 cm). For example, composites ranging in thickness from about 0.05 inch to about 6 inches (1.3 mm to 15 cm), or from about 0.06 inches to about 4 inches (1.5 mm to 10 cm) or from about 0.08 inches to about 1 inch (2.0 mm to 2.5 cm) in thickness may be made.

The fiber-reinforced composite of the present invention may, in certain embodiments, comprises a thin-layer structure. The thin-layer may comprise sufficient thickness to impart a degree of impact resistance while remaining flexible. In an embodiment, a fiber-reinforced composite may have a substantially uniform thickness and is less than 0.5 inches (13 mm) thick. In other embodiments, a fiber-reinforced composite may have a substantially uniform thickness ranging from about 0.05 to 0.25 inches (1.3 mm to 6.4 mm), or alternatively, from 0.06 to about 0.12 inches (1.5 mm to 3.1 mm). In other embodiments, a fiber-reinforced composite may have a varying thickness ranging from about 0.05 to 0.5 inches (1.3 mm to 13 mm).

Additionally or alternatively, a fiber-reinforced composite of the present invention may have a pre-defined impact strength. In an embodiment, the impact strength may be such that the fiber-reinforced composite will not fracture at room temperature (e.g., about 22° C.) when subjected to a predefined impact. In an embodiment, a fiber-reinforced composite of the present invention has an impact strength that allows the composite to pass the drop ball impact test from a 2 foot (61 cm) height as performed according to ASTM Test Procedure D1037.

A fiber-reinforced composite of the present invention may demonstrate limited swelling and shrinking upon exposure to very wet or dry conditions, respectively (e.g., a 24 hour water soak; a 24 hour oven dry; a 72 hour exposure to 93% humidity; and/or a 1 hour boil). In an embodiment, a fiber-reinforced composite of the present invention changes less than 1% of its overall volume after exposure to 24 hours of soaking in water. In an embodiment, a fiber-reinforced composite of the present invention changes less than 1% of its overall volume after exposure to 24 hours of drying in an oven at 212° F. (100° C.). In an embodiment, a fiber-reinforced composite of the present invention changes less than 0.5% of its overall volume after 72 hours exposure to 93% humidity conditions. In an embodiment, a fiber-reinforced composite of the present invention changes less than 5% of its overall volume after immersion in boiling water for 1 hour.

In an embodiment, the fiber-reinforced composite of the present invention may comprise an internal colorant or pigment to give the composite color. Suitable colorants and/or pigments include, but are not limited to, titanium dioxide, calcium sulfate, manganese dioxide, and carbon black. Color may be incorporated into fiber-reinforced composite during production of the fiber-reinforced composite. In other embodiments, color may be applied to the fiber-reinforced composite subsequent to formation of the fiber-reinforced composite structure. Color may be applied through painting and/or staining techniques known to those of skill in the art. For example, U.S. Pat. No. 6,358,614, incorporated by reference in its entirety herein, describes methods to stain non-porous thermoset articles.

In an embodiment, the fiber-reinforced composite of the present invention may comprise at least one paintable surface. As used herein, a paintable surface is a surface that has a high optical grade after painting such that there are minimal visible defects, depressions, or areas of unevenness. In alternate embodiments, the surface of the composites of the present invention have a surface with from zero to less than size 4 visible defects, or less than size 6 visible defects, or less than size 8 visible defects when evaluated according to ASTM Test Procedure D 714.

In an embodiment, a fiber-reinforced composite of the present invention may comprise a compound that is able to modify the characteristics of the surface of the composite (i.e., a surface acting agent). For example, a surface-acting agent may be used to make composite that has a surface that has a defined porosity, or a defined amount of adhesion to a second surface, or a defined smoothness.

In an embodiment, the surface-acting agent may comprise a barrier coat. As used herein, a barrier coat (or coating) is a material applied to the mold surface or to a pre-applied in-mold coating (IMC) on the mold surface. As used herein, the barrier coat is a highly resinous material that can reduce or eliminate defects by preventing air bubbles, fiber telegraphing, and other attributes that can cause defects on the surface of the final product. The barrier coat may be pigmented or neutral in color. If pigments are used, the barrier coat may be used to replace the IMC. Or, a barrier coat may be applied to the surface of the composite. Or, the barrier coat compound may be included in the mixture used to make the composite. In an embodiment, a barrier coat may be advantageous for enhancing the surface characteristics of the composition. For example, a barrier coat may be utilized to create a surface that is substantially free of pits, bubbles, fibers or fiber pieces/ends, that in certain processes may be created on a surface of the fiber-polyurethane mixture. The barrier coat may comprise an elastomer, or a non-elastomeric resin, a thermoset resin, a thermoplastic resin or the like. Examples include, but are not limited to, acrylic resins, polyolefins and other thermoplastics, polyurethane, phenol formaldehyde and other thermosets, and the like. In certain embodiments it may be advantageous to utilize a barrier coat that mechanically or chemically binds to the fiber-polyurethane mixture during molding or curing. Examples of barrier coats include BAYDUR® resins (Bayer MaterialScience, LLC), PLIOGRIP® (Ashland Specialty Chemical), Devcon 309 Methacrylate (ITW Devcon).

Also, other types of coatings, such as, but not limited to, release agent coatings may be applied to the mold, or to the composite. Examples of release agent coatings may silicone-based or wax-based release agents such as Axel 172, 35-7259 (Acmos), or polytetrafluoroethylene (PTFE) (Dupont Chemical Company).

In an embodiment, the barrier coat, release agent, or an alternative surface acting agent may be applied to the fiber-reinforced composite or the surface of a mold as an in-mold coating (“IMC”). In addition to the agents typically used as a barrier coat, an IMC may comprise any agent that may provide color, or that may provide a surface that can be further finished, or that may prevent the polymer composite from sticking to the surface of the mold. These agents include, but are not limited to, aliphatic urethanes, acrylics, alkyds, and the like. Methods for applying such surface-active agents are described in more detail below.

A fiber-reinforced composite of the present invention may be produced in any manner known to the art. Methods and systems that may be utilized to produce a fiber-reinforced composite of the present invention include the methods and systems of the present invention described herein.

As set forth above, in an aspect, the present invention provides building structures comprising fiber-reinforced composites of the present invention. Building structures comprising the fiber-reinforced composites of the present invention may include, but are not limited to, doors and their component parts, including door skins, door jambs, door sills, door frames, door panels and like; windows and their component parts, including window sashes, window frames, simulated divided light parts, window casings and the like; transoms; shutters; moldings and siding, including simulated brick moldings; walls; roofs; panels, including free-standing panels, modular panels and/or component parts of other structures (e.g., garage door panels); ceilings; sound barriers; and component parts (e.g., cladding, surface panels, plant-ons) of these structures. Each of these building structures may have the composition and characteristics described above and elsewhere herein for the fiber-reinforced composites of the present invention.

For example, in one embodiment, the fiber-reinforced composite may comprise a door or part of a door. Recently, fiberglass composite doors have become accepted by consumers. Fiberglass composite doors are highly resistant to moisture and thus, do not shrink and swell as much as wooden doors. Also, fiberglass composite doors generally do not display cracking and peeling of the veneer to the extent of some wooden doors. In addition, fiberglass composite doors may be less expensive to manufacture than wood doors, and may provide improved insulating efficiency as compared to wood doors. Fiberglass composite doors may be made using a wood frame filled with a polymeric foam-type core that is covered on both surfaces with a door skin of a fiberglass composite. The fiberglass composite door skins may be made from a sheet molding compound such as polyester resin combined with additives and fiberglass as a reinforcing material.

Still there are some disadvantages to using fiberglass composites made by conventional methods for the manufacture of fiber-reinforced polymer composites such as door skins. First, the fiberglass-reinforced polyester resins currently in use can emit significant amounts of VOCs. Also, it would be useful to be able to manufacture fiber-reinforced polymer composites having improved thermal stability, improved strength, and reduced density. In addition, there is a need for fiberglass composites that have a surface that can more realistically simulate a wood grain in appearance.

Thus, in one embodiment, the present invention provides a door skin comprising a fiber-reinforced composite of the present invention. A door skin, or a pair of door skins of the present invention, may be combined with a frame and core materials to form a door as is known to those of ordinary skill in the art. Doors and door skins produced with the fiber-reinforced composites of the present invention have advantages similar to those described herein with reference to the fiber-reinforced composites of the present invention.

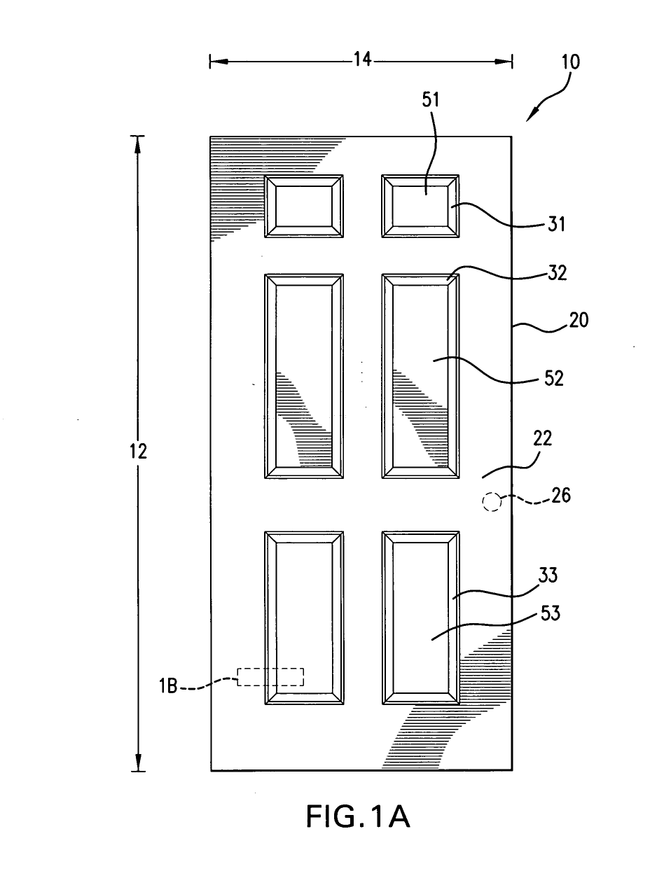

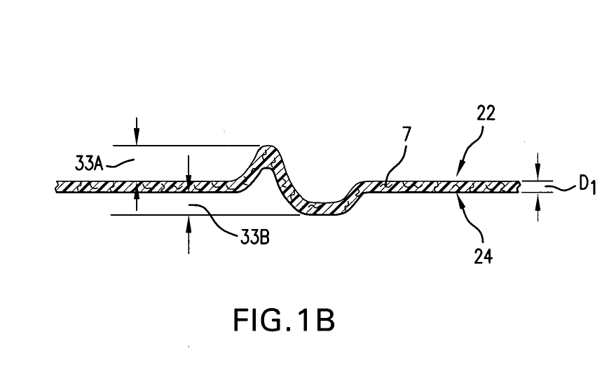

An embodiment of a door skin of the present invention is illustrated in FIG. 1. As shown in FIG. 1A and 1B, a door skin 10 may include a sheet 20 having a first outer surface 22 and a second inner surface 24. Planar surfaces of the first and second surfaces 22, 24 are generally parallel to one another. Generally, a perpendicular distance D₁ between the planar surfaces of the first surface 22 and the second surface 24 (FIG. 1B) typically is between approximately 0.05 in. (1.3 mm) and 0.130 in. (3.3 mm). In one embodiment, the distance D₁ may be between 0.08 in. (2.0 mm) and 0.120 inches (3.0 mm). The door skin may comprise an aperture 26, or several apertures, sufficient to permit mechanical components of a door latching mechanism to pass through the door skin. Shown in FIG. 1B are the fibers 7 interspersed in the polymer resin of the door skin.

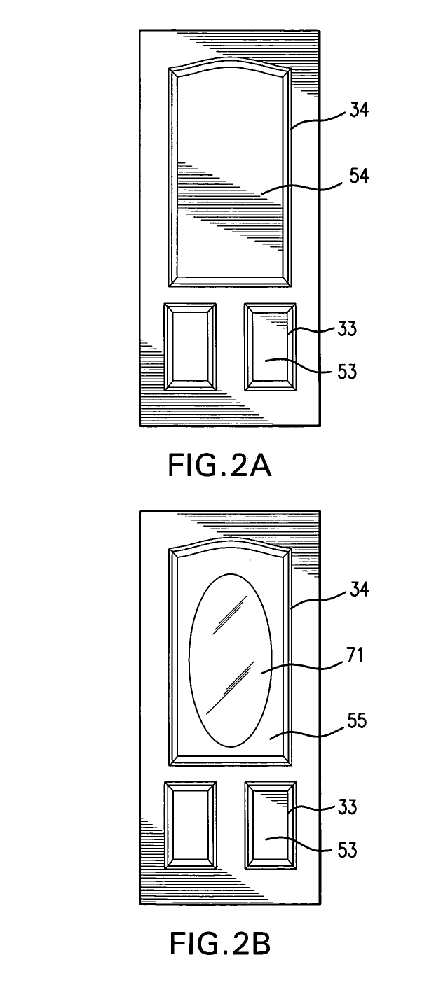

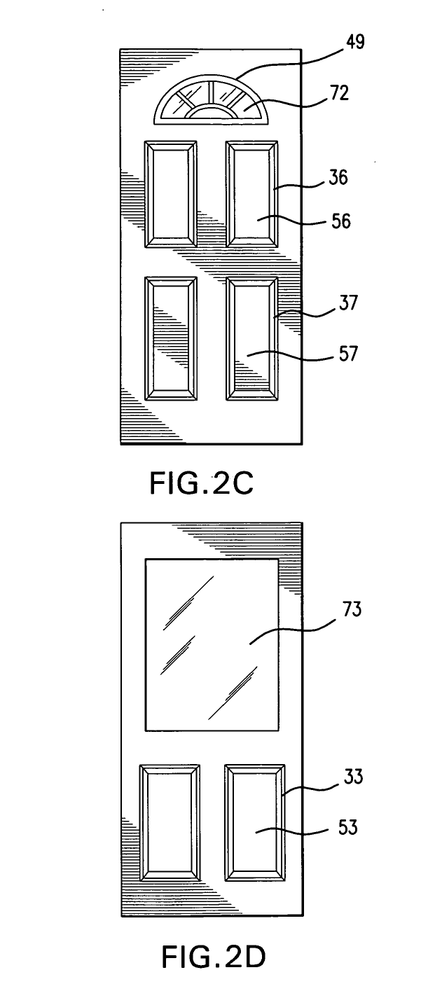

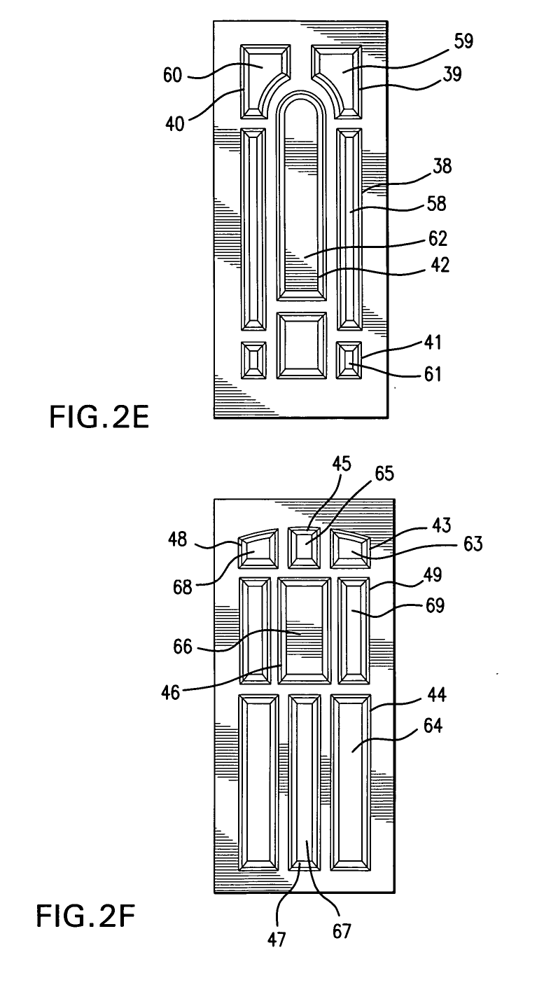

In one embodiment, the sheet 20 may include moldings, e.g., 31, 32, and 33, which surround panels, e.g., 51, 52, and 53 (FIG. 1A). The moldings may be shaped to either extend above or below the surface of the plane of the door so as to provide the appearance of wood trim. In one embodiment, the moldings 31, 32, and 33 are substantially rectangular in shape and surround panels 51, 52, and 53. Alternatively, and as shown in FIG. 2, panels A-F, other suitable of moldings, 34-49, and panels, 54-69, e.g., such as moldings and/or panels that are arcuate or curvilinear, can be used. In certain embodiments, one or more of the panel regions may be replaced at least in part with a translucent panel 71, 72, 73 (e.g., window) (FIGS. 2B, 2C and 2D). In an embodiment, the window panel 72 may comprise the entire panel and is surrounded by the molding 49 (FIG. 2C). In yet another embodiment, a window panel 73 may not be surrounded by molding, but may abut a face of the door skin (FIG. 2B and 2D).

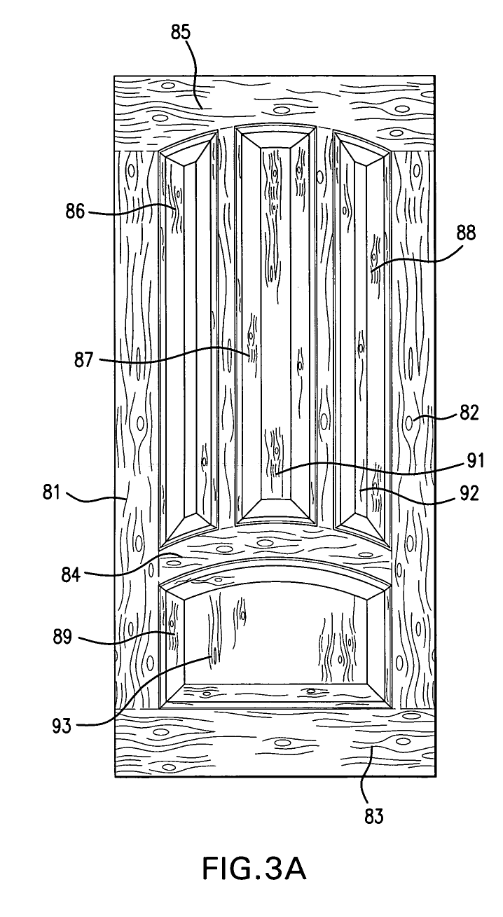

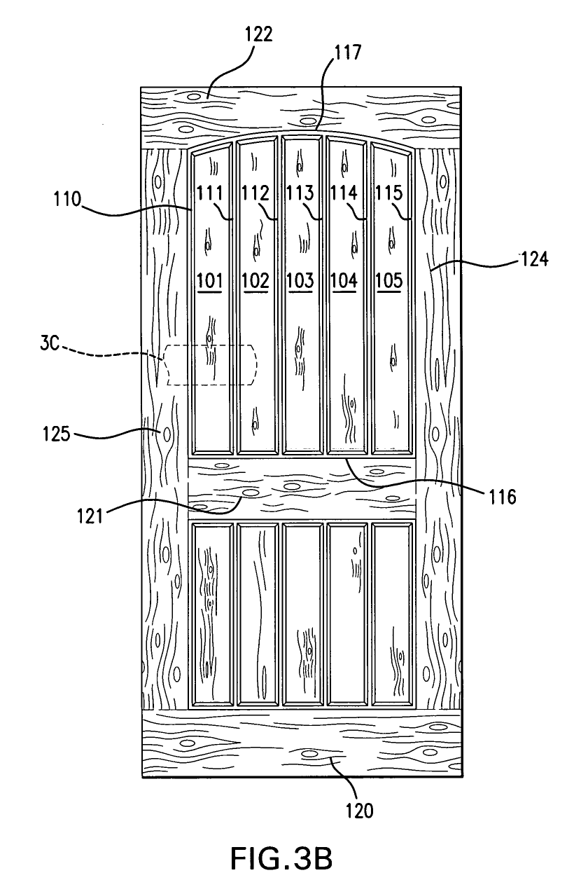

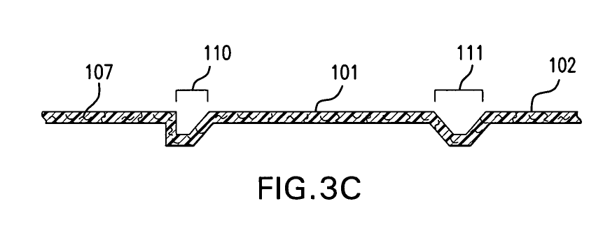

The surface of the door skin may comprise a grain pattern to simulate natural wood (FIG. 3A). The grain may be patterned to emulate the effect seen for a door made of individual wooden panels, planks and/or trim. For example, FIG. 3A shows a fiber-reinforced composite door skin of the present invention comprising vertical grain patterns 81, 82 for a part of the door skin that emulates two vertical side panels and horizontal grain patterns 83, 84, and 85 that emulate three horizontal pieces. Similarly, the grain used for molding 86, 87, 88, and 89 may comprise a pattern to emulate smaller pieces of wood that would be used for such molding, and the grain pattern used for the portion of the door skin surrounded by the molding 91, 92, 93 may comprise a pattern to emulate a flat panel.

In another embodiment, the surface of the door skin may comprise an appearance to simulate wood planking, or the like. Thus, as shown in FIG. 3B, the door skin may comprise a shape designed to create a pattern resembling multiple boards (e.g., 101, 102, 103, 104, and 105) placed in a parallel fashion. To create the pattern, depressions in the door skin surface (e.g., 110, 111, 112, 113, 114, 115, 116 and 117) may be used to outline the panels. Also shown in FIG. 3B is the use of a grain pattern on the surface of the door skin that may emulate the placement of horizontal boards e.g., 120, 121, and 122, and vertical boards 124 and 125. A cross-sectional view of the depressions used to create the appearance of planking for the portion of the door skin outlined in FIG. 3B, and showing fibers 107 interspersed as part of the fiber-reinforced composite is shown as FIG. 3C.

The height 12 and width 14 (FIG. 1) of the door skin will vary depending on the desired door size. Typically, for the U.S., European, and Australasia markets an external door may have a height of 6 feet 5 inches to 8 feet (2.01 m to 2.44 m) and a width of 2 feet 4 inches to 3 feet 6 inches (0.7 m to 1.1 m). Typical internal passage doors may have a height of 6 feet 8 inches to 8 feet (1.8 m to 2.4 m) and a width of 1 foot 10 inches to 3 feet 6 inches (0.5 m to 1.1 m). A door skin of the present invention may have similar dimensions or may be somewhat larger than the door to allow for trimming or to allow the door skin to at least partially wrap around the door frame stiles and/or rails.

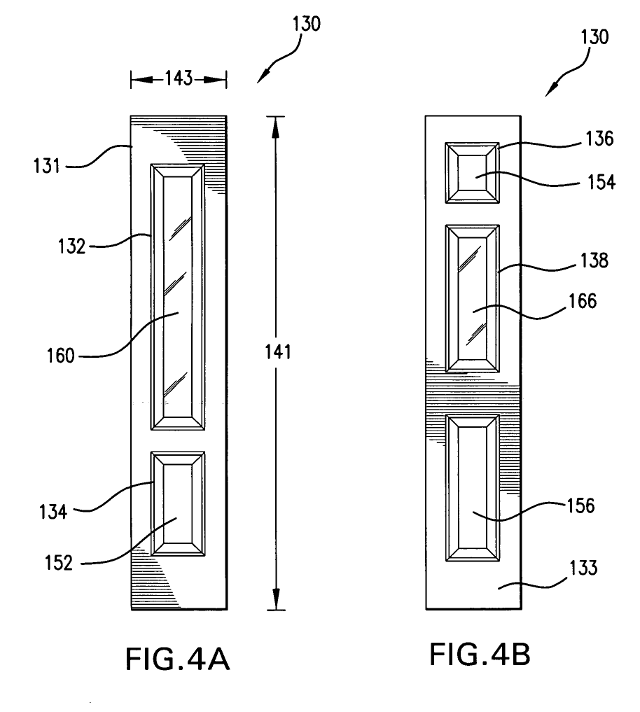

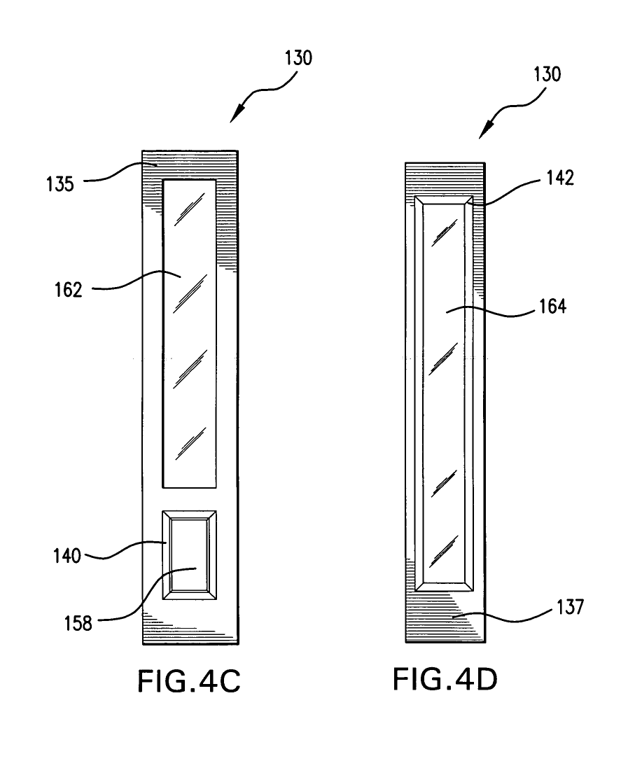

In another embodiment, the present invention provides sidelights, or parts of sidelights comprising the fiber-reinforced composites of the present invention. As used herein, a sidelight comprises a structure that may be positioned adjacent to (i.e., to the side of) a door, and that provides a window unit. Generally, the sidelight may provide a design that is similar to, and thus complements the design of the door. Sidelights that may comprise the fiber-reinforced composites of the present invention are shown in FIG. 4, panels A-D. Similar to doors, sidelights 130 may include moldings, 132, 134, 136, 138, 140, 142, panels, 152, 154, 156, 158, and translucent panels, 160, 162, 164, and 166. In one embodiment, the fiber-reinforced composite may comprise a thin-layer structure 131, 133, 135, 137, similar to a door skin that is used to cover a the sidelight frame and any core material. For example, in an embodiment, the fiber-reinforced composite of the present invention may be shaped as a flat panel into which a glass pane may be inserted. The fiber-reinforced composites of the present invention may comprise increased strength as compared to wood panels and thus may be particularly suited to support the weight of a glass pane. Alternatively, the fiber-reinforced composite may comprise a substantial portion of the structure of the sidelight. For example, in an embodiment, the fiber-reinforced composite may comprise the entire sidelight structure except for the window.

The height 141 and width 143 of the sidelight may vary. Typically, for the U.S., European and Australasia markets, a sidelight will have a height of 6 feet 7 inches to 8 feet (2.0 m to 2.4 m) and a width of 9 inches to about 1 foot 6 inches (0.2 m to 0.5 m).

In an embodiment, wherein the height of the door skin is 72 inches (183 cm) to 96 inches (244 cm) and the width of the door skin is 24 inches (61 cm) to 42 inches (107 cm), the molding (e.g., 31, 32 and 33 in FIG. 1) may be raised from the surface of the door skin (e.g., 33A, FIG. 1B) by about 0.125 inches to about 1.5 inches (3.2 mm to 38 mm) and/or extend below the surface of the door (e.g., 33B, FIG. 1B) by about 0.125 inches to about 0.562 in. (3.2 mm to 14.3 mm). The molding may be positioned almost anywhere within the face of the door skin. In one embodiment, the moldings may be positioned anywhere from about 2 inches to about 10 inches (50 mm to 254 mm) from one edge and about 2 inches to about 10 inches (50 mm to 254 mm) from the other edge of the door skin.

In another embodiment, the present invention provides panels and/or parts of panels comprising the fiber-reinforced composites of the present invention. The panels may comprise door panels, wall panels, sidelight panels or any other type of panel that may be used in a building structure.

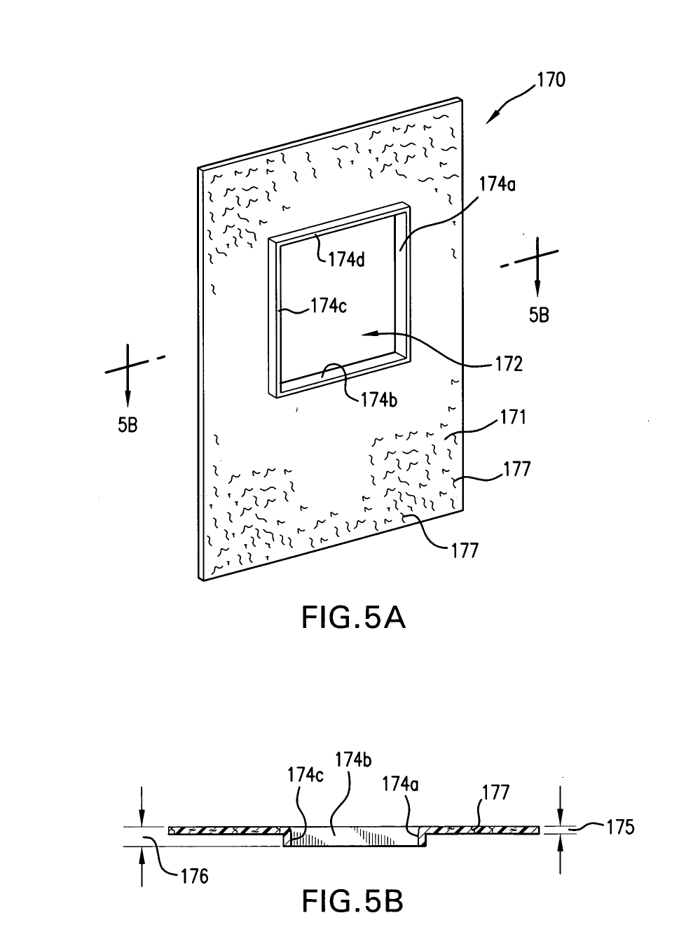

For example, in one embodiment, the present invention provides panels to support the insertion of a glass pane in a side light or a door comprising the fiber-reinforced composites of the present invention. Generally, insertion of a window pane in a door may utilize supporting molding as described in commonly owned U.S. Pat. No. 6,485,800. The disclosure of U.S. Pat. No. 6,485,800 is incorporated in its entirety herein. Due to the strength of thin-layer fiber-reinforced composites of the present invention, however, such supportive moldings may not be required to insert a glass pane in a door panel or sidelight. For example, FIG. 5, panels A and B, illustrates an embodiment of a thin-layer fiber-reinforced composite 170 that comprises a flat fiber-reinforced composite panel 171 into which has been molded an aperture 172 having supportive edges or lips 174a, b, c, and d, into which can be positioned a glass pane. Also shown are fibers 177 that may be visible, in some embodiments, on the back side of the panel. In an embodiment, the panel 171 may range from about 0.04 inches (1 mm) to about 0.3 inches (7.6 mm) in thickness 175. Also in an embodiment, the supportive edge (or lip) may range from about 0.05 inches (1.2 mm) to about 0.5 inches (12.7 mm) in depth (i.e., behind the plane of the panel surface) 176 to provide support for a glass panel.

In another embodiment, the present invention provides door panels for garage doors comprising the fiber-reinforced composites of the present invention. The garage door panels may be flat (i.e., “flush”), or may comprise a pattern. In one embodiment, the panels may be molded such that the pattern is included as part of the panel or the door skin used to form the pattern. Alternatively or additionally, garage doors may comprise plant-on structures to form the pattern.

As used herein, a “plant-on” comprises a structure that may be adhered to, or mechanically “planted-on” the inner or outer surface of a planar object to provide a raised surface. In one embodiment, the plant-on structure may comprise a decorative trim. The plant-on structure may have a variety of shapes or forms. In one embodiment, the plant-on structure may be about 1/16 to 2 inches (1.5 mm to 51 mm) thick and rectangular in shape. Or, a plant-on may comprise a structure that is oval or round in shape. Or, plant-on structures of other shapes, sizes and thickness may be used.

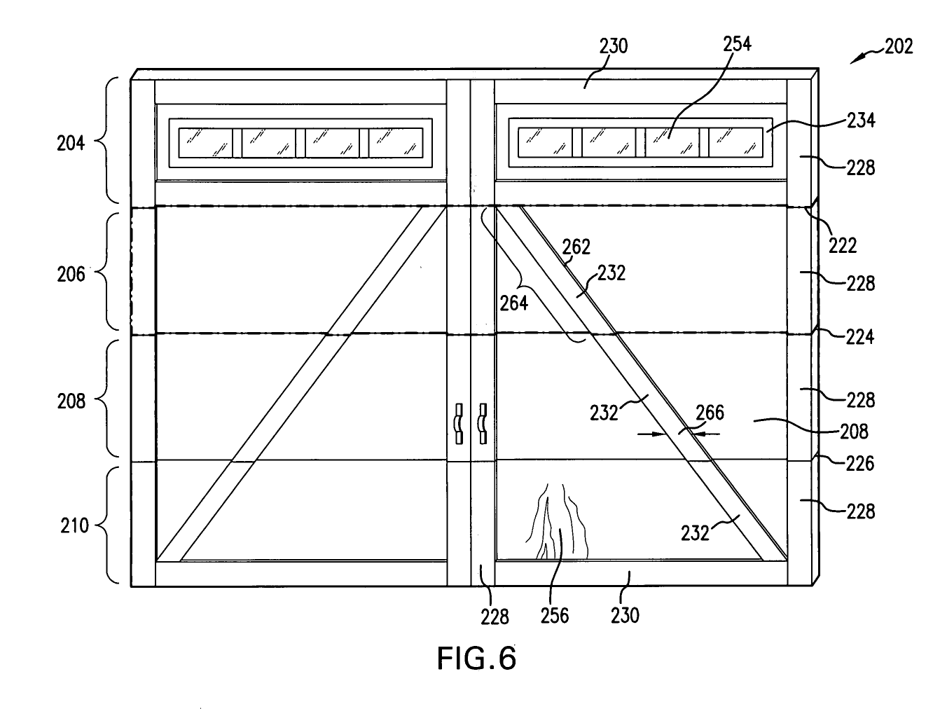

FIG. 6 shows an example garage door panel that may be made using the fiber-reinforced composite of the present invention. Thus, a garage door 202 shown may comprise multiple composite panels 204, 206, 208, and 210, separated at junctures 222, 224, and 226. In an embodiment, the fiber-reinforced composite of the present invention is used to make the individual garage door panels (e.g., 204, 206, 208, and 210). In FIG. 6, panel 206 is outlined to show the extent of the panels. The panels may be fashioned so that one panel may interlock with another door panel. For example, the seam 222 between panels 204 and 206 may comprise a protruding portion or tongue on one panel, that fits into a groove on an adjacent panel. Methods for making garage door panels are described in commonly owned U.S. patent application Ser. No. 10/997,244, filed Nov. 24, 2004, the disclosure of which is incorporated by reference in its entirety herein.

In an embodiment, the present invention provides plant-on structures comprising the fiber-reinforced composites of the present invention. FIG. 6 shows an embodiment wherein multiple plant-ons have been positioned on the surface of the outer door skin of a garage door. By the positioning of various plant-ons on the outer surface of the door panel 208, the overall appearance of the door may be not that of four horizontal panels, but of two single-panel swing doors. For example, individual plant-ons 228 may span the vertical length of the door, and mesh almost seamlessly at junctions 222, 224, and 226, to appear as a single vertical trim on the face of the door. Also, diagonally placed plant-ons 232 may provide a single, unified design feature to create the impression that the door is actually two single paneled doors that may swing open, rather than a roll-up door made of four horizontal panels. Even horizontal plant-ons 230, although they may not span different panels, provide a design that is coordinated with the other plant-ons so as to create the impression that the door is actually two single-paneled swing doors (FIG. 6). Also, the fiber-reinforced composite used to form the garage door panels and/or plant-ons may comprise a pattern 256 to simulate a wood grain pattern.

The plant-ons may be a variety of shapes and sizes such that they stand out from the surface of the garage door to provide raised surface or relief. In various alternative embodiments, the plant-ons may range from about 1/16 to 2 inches (1.59 mm to 50.8 mm), or from about ⅛ inch to 1 inch (3.2 mm to 25.4 mm), or from about ¼ inch to ¾ inch (6.4 mm to 19.1 mm) in thickness 262 (FIG. 6). In one example embodiment, the plant-on may be about ⅜ (9.5 mm) inch thick. The width 266 and length 264 (FIG. 6) of the plant-ons may vary depending upon the size of the door panel and the size of the trim required. The length of the plant-on may also vary, but generally will not be longer than the diagonal length of the panel. Also, different plant-ons on the same face of a door may be different sizes.

Still referring to FIG. 6, the door panel may comprise translucent panels 254 (e.g., windows) inserted within an aperture cut into a thin-layer fiber-reinforced composite. The surface of the garage door panel may be flush with the window pane, or it may comprise a trim 234 to accentuate the window pane. In one embodiment, the trim may be a fiber-reinforced composite plant-on.

The panel itself may be sized to fit a standard garage door. In one embodiment, the panels are 78 to 144 inches (2.0 m to 3.7 m) across for use as a single car garage door. Alternatively, panels may range from 192 to 216 inches (4.9 m to 5.5 m) across for use as two car garage doors. Also, the vertical axis (i.e., height) for the panel may vary as needed. In one embodiment, four panels may be used for a garage door. Alternatively, three to six panels may be used for a garage door. Or, in some cases, the garage door may comprise a single panel. In some cases, panels of different sizes may be used for a single door. For example, in the case of a garage door including windows as part of the top panel, a larger top panel may be used with smaller lower panels. In one example embodiment, a top panel 24 inches (61 cm) in height may be used with three 20 inch (51 cm) lower panels. Or, four 21 inch (53 cm) high panels may be used. For example, where the window is 16 inches (41 cm) high, a 24 inch (61 cm) high panel may be preferred. In contrast, a 13 inch (33.0 cm) window may be fitted into a 21 inch (53 cm) high panel.

Thus, the present invention may provide a door, door panel, sidelight, or portions thereof (e.g., plant-ons) comprising a fiber-reinforced composite of the present invention. Each face of the door or door panel may comprise a fiber-reinforced composite door skin. The same or different door skin designs may be used for each face. Similarly, each face of a sidelight may comprise a thin-layer fiber-reinforced composite.

A door or door panel of the present invention may be constructed in manners generally known to those of ordinary skill in the art as described in commonly owned US Pat. Nos. 6,485,800, 6,067,699, and 5,852,910, as well as commonly owned U.S. Patent application Ser. No. 10/269,522, filed Oct. 11, 2002, Ser. No. 10/284,392, filed Oct. 31, 2002, and Ser. No. 10/443,627, filed May 22, 2003. The disclosure of each of the patents and patent applications is incorporated by reference in its entirety herein. For example, as is known in the art, a door, a door panel, or sidelight may comprise a frame and a core. The frame may comprise at least two vertical stiles and two horizontal rails. The frame of the composite door panel may be designed to provide support for the door. Also, in one embodiment, as for example, where the panel is used for a garage door, the frame may be fashioned so that adjacent panels in a door may interlock. For example, to provide interlocking garage door panels, the rails of the frame may be banded (e.g., with pieces of wood or other material) to provide a means to have adjacent panels interlock. The band may include a protruding element (i.e., a tongue), or the band may include a groove. In this way, the protruding element on the end of one door panel may be inserted into a groove on the end of another panel to provide an almost seamless, interlocking junction between the two panels. In one embodiment, the frame is made using laminated veneer lumber (LVL). LVL is a structural lumber manufactured from veneers laminated into a panel. Or, the frame may be made of solid or fingerjointed wood, composites such as extruded wood and plastic, steel or other metal, or other material of acceptable performance and appearance.

The core of the door, door panel, sidelight, or plant-on structure may be formed to at least partly fill voids or spaces in the frame that are enclosed by the fiber-reinforced composite layer. The core may comprise an insulating material, such as a synthetic polymer foam. For example, the core may comprise an expanded polystyrene foam or a polyurethane foam, particleboard, gypsum, or other mineral wood staves and the like. Alternatively, laminated veneer lumber (LVL) or cardboard may be used to at least party fill the core. In other embodiments, the doors and/or door panels are substantially hollow such that the core comprises a substantial proportion of air.

The core material may comprise a density similar to the density of wood. Or, the core material may be much lighter than wood. In one embodiment, expanded polystryrene having a density of from about 1.0 to about 1.5 pounds per cubic foot (pcf) is used.

Also, color may be incorporated into the fiber-reinforced composite during production of the fiber-reinforced composite. In other embodiments, color may be applied to the fiber-reinforced composite subsequent to formation of the fiber-reinforced composite structure. Thus, color may be applied through painting and/or staining techniques known to those of skill in the art.

The present invention may provide other building structures comprising the fiber-reinforced composites of the present invention. For example, in some embodiments, the present invention may provide door frame parts or window frame parts, or cladding for door frames and/or window frames comprising the fiber-reinforced composites of the present invention.

As described above, like other building structures, wood door frames and window frames may warp due to shrinkage and swelling upon exposure to extremes in temperature and/or humidity. Some attempts to reduce reliance on wooden door and window frames have included the use of plastic or vinyl clad wooden frame members (see, e.g., U.S. Pat. Nos. 5,987,843, 6,295,779, and 6,378,266). Alternatively, door frames that are entirely synthetic have been developed. Plastic frame members may be attractive from a manufacturing standpoint in that they can be molded to provide a desired shape, and can accommodate attachment fixtures without the use of nails, screws or other types of fasteners (see e.g., U.S. Pat. No. 6,393,779). In general, however, plastic may not be strong enough to support a door or window unit. Also, metal door frames, or door frames having metal cladding, have been developed (see e.g., U.S. Pat. No. 6,604,334). Still, metal cladding may not be as aesthetically pleasing to some consumers. Also, similar to metal doors, metal door frames and window frames may suffer from environmentally induced weathering, such as rust and photochemical deterioration, and can be poor insulators in hot and cold environments.

Thus, in some embodiments, the fiber-reinforced composite structure of the present invention may be molded into variety of shapes, such as, but not limited to, a vertical doorjamb, a header jamb, or a door sill. In one embodiment, the jambs may be flat. Alternatively, the jambs may be rebated. In another embodiment, the fiber-reinforced composite structure of the present invention may comprise a window frame member. In other embodiments, the fiber-reinforced composite structure of the present invention may comprise lineal moldings such as casing and brickmold profiles, mull posts, door stops, plinth blocks, or astragals. In yet another embodiment, the present invention may provide cladding for such parts comprising a fiber-reinforced composite of the present invention. As used herein, cladding comprises a covering or a coating on a structure or material.

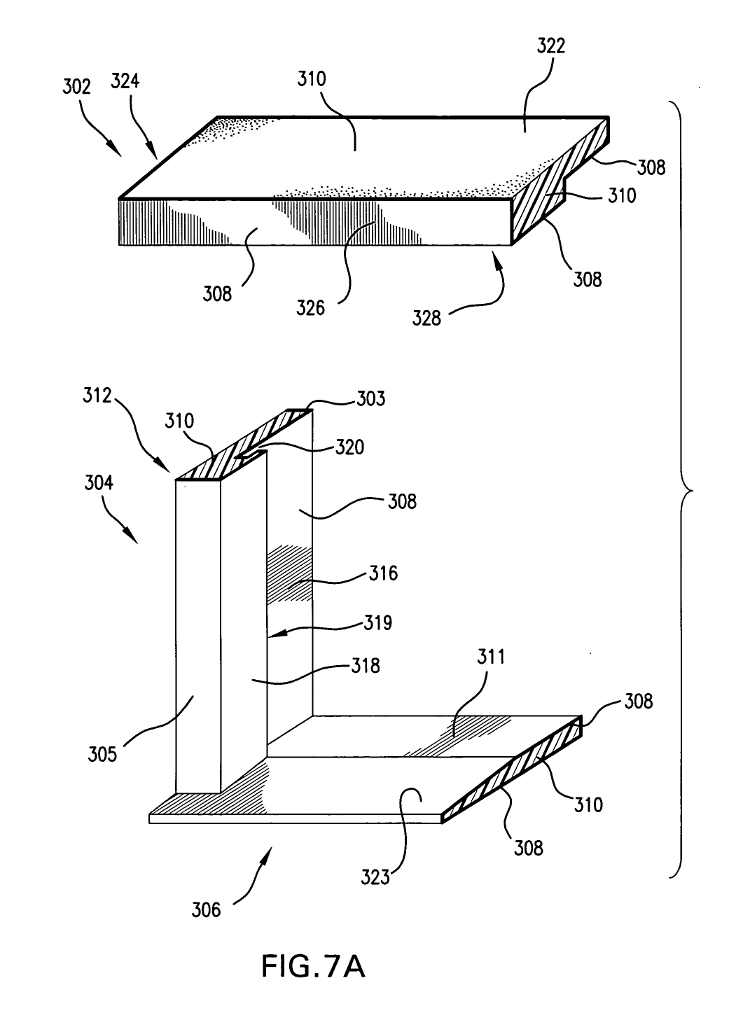

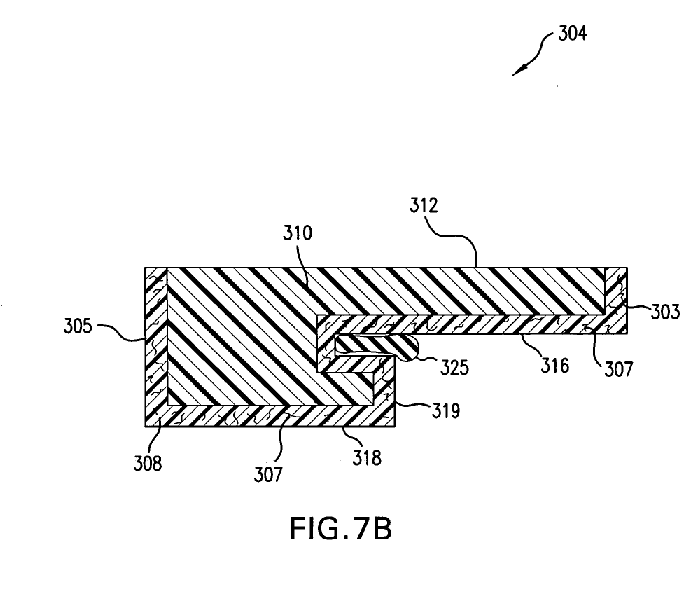

FIG. 7, panels A and B, illustrate an embodiment of a fiber-reinforced composite structure of the present invention as embodied in a door frame. Each door frame section in FIG. 7A is shown as a partial cross section showing an outer fiber-reinforced composite cladding 308 of the present invention and inner core 310. As shown in FIG. 7A, a door frame may comprise a header jamb 302 that defines the upper part of the door opening, a left doorjamb 304 and right doorjamb (not shown) that frame the sides of the door, and a sill 306 as the bottom of the frame. The sill 306 may further comprise portion 323 that is slanted to facilitate run-off of water away from the door, and a substantially flat portion 311 that provides a base for the door. Not shown in FIG. 7A is the door which, in the view shown, would hang from the right jamb and swing away from the viewer. As depicted in FIG. 7A, side 305 faces the outside of the building (or doorway) and opposite side 303 faces the inside of the building (or doorway). In this orientation, surfaces 316 and 318 form the side of the jamb that makes up the door opening, and surface 312 is the side of the jamb that is adjacent to the building structure.

It can be seen that the side of the jamb 304 that makes up the doorway may comprise two distinct surfaces, 316 and 318, such that the jamb may be thicker in the part of the jamb that is on the exterior of the door when the door is closed, and a thinner in the part of the jamb that is on the interior side of the jamb. Surface 319 may provide a stop against which a door, when seated in the frame and closed, will rest. In some cases, a molding or weather stripping may be inserted in groove 320, adjacent to face 319, to provide a cushion and insulating surface for the closed door. Similarly, header jamb 302 may comprise surfaces, 322 and 324, that are adjacent to the building, and surfaces, 326 and 328, that comprise the surface of the frame opening and thus, comprise exterior surfaces of the headerjamb.

FIG. 7B shows a cross-sectional view of side doorjamb 304 where the fiber-reinforced composite 308 is used as a cladding for the structure. In FIG. 7B, side 305 is the surface that faces the outside of the doorway or building, surfaces 316 and 318 are the surfaces in the doorway opening, surface 303 faces the interior of the doorway, and surface 312 is the side of the jamb that is attached to the building structure. Molding or weather stripping 325 may be used to cushion the door so that when the door is closed it maintains a tight seal. As shown in FIG. 7B, side jamb 304 may comprise a cladding 308 of the present invention that surrounds an inner core 310. In one embodiment, the cladding 308 comprises a polymer reinforced with fibers 307. Thus, cladding 308 may provide a surface or shell that is exposed to the exterior side of the doorway (e.g., surfaces 303, 305, 316, 318 and 319). In an alternate embodiment, the fiber-reinforced composite cladding of the present invention may cover each and every face of the door frame or window frame part as is shown for the door sill of FIG. 7A. Or, the entire frame part, including the core may comprise the fiber-reinforced composite of the present invention.

Where the fiber-reinforced composite of the present invention comprises a cladding for the door frame part or the window frame part, the cladding may comprise a thickness as is required by the particular application. In alternate embodiments, the thickness of the cladding may range from about 1/64 inch to about 2 inches (0.4 mm to 51 mm), or from about 1/32 inch to about ¾ inch (0.8 mm to 19 mm), or from about 1/16 inch to about ¼ inch (1.5 mm to 6.4 mm)

The core of the door frame of the present invention part may comprise a core similar to that used for a door. Alternatively, the core may comprise expanded polystyrene, cellular PVC, foamed urethane, wood, LVL, or other material acceptable for performance.

Also, a fiber-reinforced composite door frame or frame part of the present invention may have color incorporated during production of the fiber-reinforced composite. In other embodiments, color may be applied to the fiber-reinforced frame or frame part subsequent to formation of the fiber-reinforced composite structure. Thus, color may be applied through painting and/or staining techniques known to those of skill in the art.

In alternate embodiments, the present invention may provide siding comprising a the fiber-reinforced composite of the present invention. For example, the siding of the present invention may be used in place of vinyl, fiber-cement, and other conventional siding products. A fiber-reinforced composite siding of the present invention may comprise any desired length, width, thickness, and/or shape. In some embodiments, for example, the fiber-reinforced composite siding may have a length ranging from about 8 feet to about 18 feet (5.5 m) and a width of about 8 inches (20.3 cm) (Double 4″) to about 10 inches (25.4 cm) (Double 5″). The thickness of a fiber-reinforced composite siding, in some embodiments, for example, may range from about 0.125 inches (3.2 mm) to about 0.75 inches (19 mm). Moreover, a fiber-reinforced composite siding may have a system height ranging from about 0.125 inches to about 2 inches (3.2 mm to 51 mm). In some embodiments, a fiber-reinforced composite siding may further comprise structures suitable for locking individual siding pieces together such as those developed for vinyl and aluminum siding applications.

A fiber-reinforced composite siding may, in some embodiments, comprise various profiles including Double 4″ traditional lap, Double 5″ traditional lap, Double 4″ Dutch lap, Double 5″ Dutch lap, and/or vertical siding/soffit. The fiber-reinforced composite siding may be solid and/or vented. For example, fiber reinforced composites used as vertical siding/soffit may be vented. Venting in fiber-reinforced polymer composite siding may assist in air circulation, which may help control heat and humidity in an attic space or other areas where required.

In some embodiments, a fiber-reinforced composite siding of the present invention may further comprise at least one layer of insulation. The insulation may be secured to one face of a fiber-reinforced composite siding. For example, the insulation may be secured to the inside face of a fiber-reinforced composite siding such that when the siding is installed, the insulation is disposed between the wall of the structure and the fiber-reinforced polymer composite material. In alternate embodiments, the insulation may comprise fiber glass, rock wool, cellulose, polyurethane foam, extruded polystyrene foam, expanded polystyrene foam, (EPS or beadboard), polyurethane foam, polyisocyanurate foam, and/or combinations thereof.

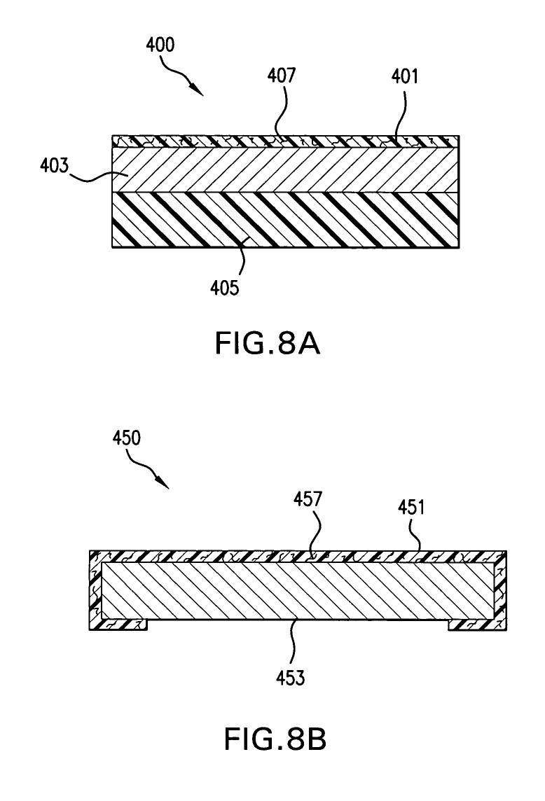

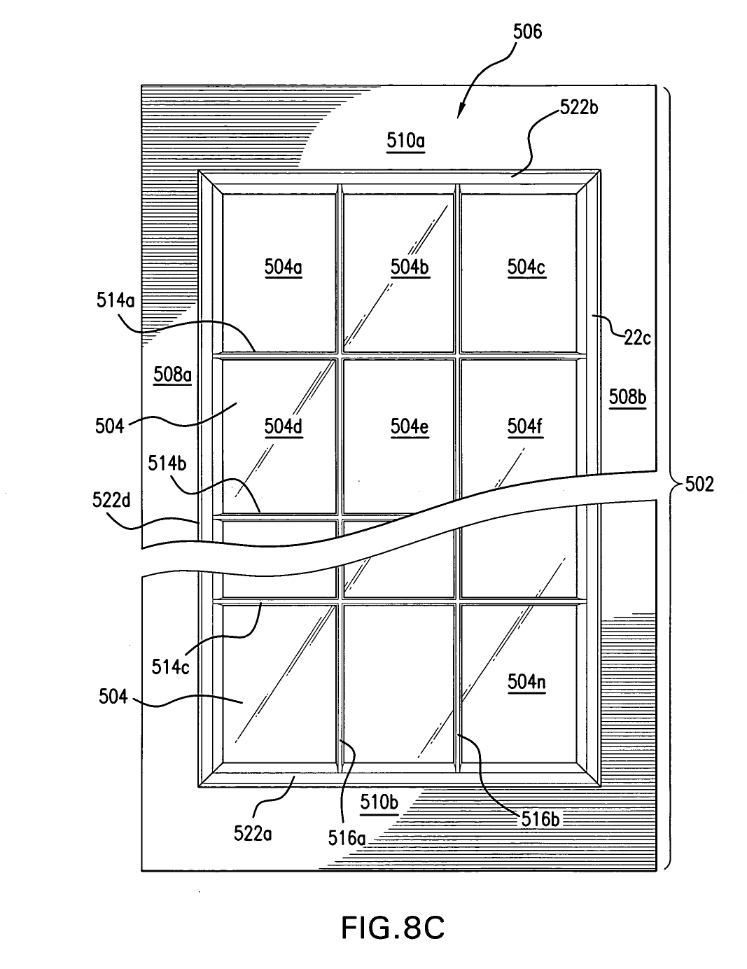

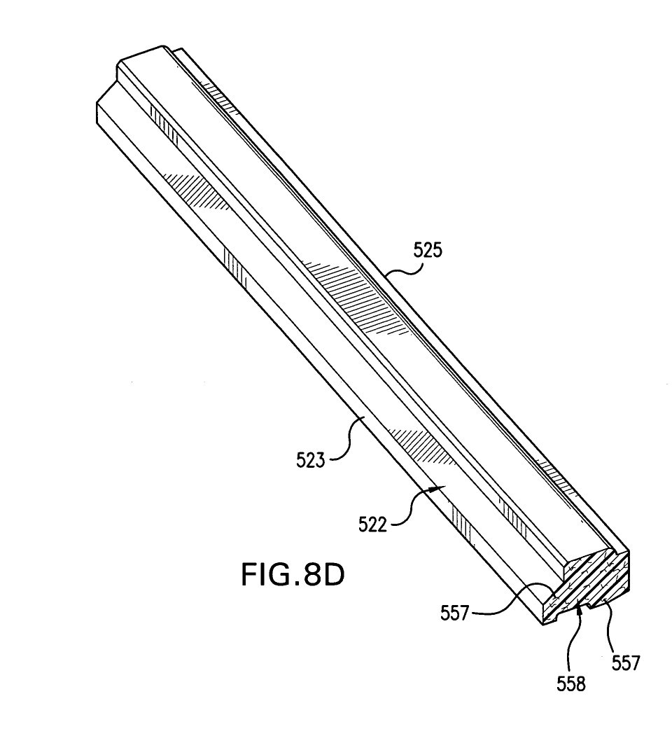

The fiber-reinforced composite siding of the present invention may comprise a fiber-reinforced polymer composite layer and a substrate layer. The substrate layer may comprise a cellulose-based material such as plywood, particleboard, oriented strand board, and/or combinations thereof. Or, the substrate may comprise recycled wood materials. A fiber-reinforced polymer composite layer, in some embodiments, may be secured to the substrate layer by at least one adhesive or any means known to one of skill in the art. FIG. 8A illustrates a cross-sectional view of a fiber-reinforced polymer composite siding 400 comprising a fiber-reinforced polymer composite layer 401 including fibers 407, a substrate layer 403, and an insulation layer 405, according to one embodiment of the present invention.

The fiber-reinforced composite siding of the present invention, in some embodiments, may comprise a wood-grain appearance operable to simulate various wood types, such as oak, pine, cedar, etc. In other embodiments, fiber-reinforced composite siding may comprise a smooth appearance. In some embodiments, fiber-reinforced composite siding may further comprise a fire retardant composition.

The fiber-reinforced composite siding of the present invention may comprise any desired color. Color may be incorporated into a fiber-reinforced composite siding during production of the fiber-reinforced composite. In other embodiments, color may be applied to the fiber-reinforced composite siding subsequent to formation of the siding. For example, color may be applied through painting and/or staining techniques known to those of skill in the art.

In other embodiments, the present invention may provide shingles comprising a fiber-reinforced composite of the present invention. A fiber-reinforced composite shingle may comprise any desired length, width, thickness, and/or shape. In some embodiments, for example, a fiber-reinforced composite shingle may comprise a length ranging from about 12 inches (30.5 cm) to about 24 inches (61 cm) and a width of about 5 inches (12.7 cm) to about 12 inches (30.5 cm). The thickness of a fiber-reinforced polymer composite shingle, in some embodiments, for example, may range from about 0.040 inches (about 1.0 mm) to about 0.60 inches (about 15.2 mm). In an embodiment, the shingles may range from about 0.04 inches (1.0 mm) to about 0.12 inches (3.0 mm) in thickness. Or thicker shingles ranging from about 0.24 inches (6.0 mm) to about 0.35 inches (9.0 mm) may be used. Moreover, a fiber-reinforced composite shingle of the present invention may have any desired exposure area. For example, the fiber-reinforced composite shingle may have an exposure area ranging from about 50 percent to 70 percent of the total area of the shingle. Also, the fiber-reinforced composite shingles may further comprise designated nailing locations which may facilitate installation of the fiber-reinforced shingles.

In some embodiments, fiber-reinforced composite shingles of the present invention may comprise a wood-grain appearance. In other embodiments, the fiber-reinforced composite shingles may comprise a slate appearance. The fiber-reinforced composite shingles may comprise any desired color. Color, in some embodiments, may be incorporated into fiber-reinforced composite shingles during production of the fiber-reinforced composite. Or, color may be applied to fiber-reinforced composite shingles subsequent to formation of the shingles. For example, color may be applied through painting and/or staining techniques known to those of skill in the art.

In some embodiments, the fiber-reinforced composite shingles of the present invention may further comprise a fire retardant composition. Fiber-reinforced composite shingles, in some embodiments, may be used in roofing and/or siding applications.

In other embodiments, the present invention provides shutters comprising the fiber-reinforced composites of the present invention. A fiber-reinforced composite shutter may comprise any desired height, width, thickness, and/or shape. In some embodiments, a fiber-reinforced composite shutter may comprise a height ranging from about 25 inches (about 64 cm) to about 80 inches (about 203 cm). In some embodiments, a fiber reinforced composite shutter may comprise a width ranging from about 8 inches (about 20 cm) to about 36 inches (about 92 cm). The fiber-reinforced composite shutters may comprise various designs including louvered shutters, raised panel shutters, and/or board and batten shutters.

In another embodiment, the present invention provides hurricane shutters comprising a fiber-reinforced composite of the present invention. A fiber-reinforced composite hurricane shutter of the present invention may comprise any desired height, width, and/or thickness. In some embodiments, the fiber-reinforced polymer composite hurricane shutters may meet and/or exceed code requirements of regions exposed to hurricanes and other severe storms such as south Florida (e.g., Dade County, Florida).

In an embodiment, the fiber-reinforced composite hurricane shutters of the present invention may comprise at least one fiber-reinforced polymer composite layer and a substrate layer. The substrate layer may comprise a cellulose based material such as plywood, particleboard, oriented strand board, and/or combinations thereof. In an embodiment, the substrate may comprise recycled wood materials. The fiber-reinforced composite layer may be secured to the substrate layer by at least one adhesive or any means known to one of skill in the art.

Additionally or alternatively, the present invention may provide reinforcing covers for hurricane shutters comprising the fiber-reinforced composites of the present invention. The fiber-reinforced composites may be produced having dimensions suitable for covering existing hurricane shutters. The fiber-reinforced composite hurricane shutter covers may increase the strength and/or durability of existing hurricane shutters. In some embodiments, fiber-reinforced composite covers for hurricane shutters may be secured to hurricane shutters by nails, screws, hinges, etc. Additionally or alternatively, fiber-reinforced composite covers may be secured to hurricane shutters by at least one adhesive. In another embodiment, the fiber-reinforced composite covers may be secured to hurricane shutters by a friction fit. For example, FIG. 8B illustrates a cross-sectional view of a hurricane shutter 450 comprising a fiber-reinforced composite cover according to one embodiment of the present invention. In the embodiment shown, the fiber-reinforced composite cover 451 having fibers 457 is adapted to be secured to the hurricane shutter 453 by a friction fit. The fiber-reinforced composite 451 may slide over the hurricane shutter 453 resulting in a secure fit.

The fiber-reinforced composite shutter, hurricane shutter, or shutter cover may comprise a color. Color, in some embodiments, may be incorporated into the fiber-reinforced composite covers during production of the fiber-reinforced composite. In other embodiments, color may be applied to the fiber-reinforced composite subsequent to formation of the shutters or covers, as for example, by painting and/or staining techniques known to those of skill in the art. The fiber-reinforced composite used for the shutters or shutter covers may comprise a wood grain appearance. In other embodiments, fiber-reinforced composite may comprise a smooth appearance.

As described above, the present invention may also provide window frame parts and window parts, including, but not limited to window sills, window frames, window sashes, glass stops, and simulated divided light (SDL) bars (e.g., muntins), comprising the fiber-reinforced polymer composites of the present invention. As used herein, the window frame comprises the frame that receives and holds the window sash and a window sill is a generally flat portion at the bottom of the frame. A fiber-reinforced composite window part of the present invention may comprise any desired height, width, thickness, and/or shape as is required by the part. In some embodiments, the fiber-reinforced composite window part or window frame part may have a wood grain appearance. In other embodiments, the fiber-reinforced polymer composite window part or window frame part may have a smooth appearance. In another embodiment, the present invention may provide cladding for such window parts and/or window frame parts comprising a fiber-reinforced polymer composite of the present invention. For example, the present invention may provide cladding for a window sill, a window frame, a window sash, a glass stop, or a muntin bar wherein the cladding comprises a fiber-reinforced composite of the present invention.

For example, as shown in FIG. 8C, a simulated divided light window panel 502 may comprise a glass pane 504 surrounded by a sash 506. The glass pane 504 may comprise a single glass pane or a double glass pane, where the pane fills the area surrounded by the sash. As used herein, a sash comprises a support used to hold glass in a window that may slide up and down (or side to side) in the grooves of a window frame aperture. Alternatively, the glass pane is used in a door, and is surrounded by a door panel. The sash (or door panel) is comprised of two vertical stiles, 508a and 508b, and two horizontal rails, 510a and 510b. Within the sash 506 and attached thereto, are horizontal simulated divided light (SDL) bars (e.g., muntins), e.g., 514a, 514b, and 514c, and vertical SDL bars, e.g., 516a and 516b. As used herein, SDL bars, or muntins, comprise non-transparent strips or bars that are used to divide a transparent panel into sections. The set of interlocking SDL bars (e.g., 514a, 514b, 514c, 516a, and 516b) can be seen to resemble a grid. It can be seen that the SDL bars appear to segment the pane of glass 504 into separate quadrants or sections (e.g., 504a, 504b, 504c, etc., depending on the number of SDL bars). Also, there may be a glass stop 522 positioned to overly the junction of the sash 506 and the window 504. The glass stop 522 may comprise four strips, 522a, 522b, 522c, and 522d, generally made to appear as the same material as is used for the sash or door panel. The strips that make up the glass stop may be applied around the perimeter of the glass 504 and flush to the surrounding sash or door panel 506. The stop 522 may cover the junction between the glass pane and the surrounding sash or door panel as well as any visible adhesive from view, and thus, can provide an attractive boundary around the glass.

The fiber-reinforced composites of the present invention may be used to form any of the parts of the window or window frame. For example, for the window as shown in FIG. 8C, sash 508, 510, glass stops 522, and/or SDL bars 514 may comprise a fiber-reinforced composite of the present invention. Or, the window frame and/or sill may comprise a fiber-reinforced composite of the present invention. FIG. 8D shows a representation of an embodiment of a glass stop 522 comprising the fiber-reinforced composite 558 of the present invention comprising fibers 557 and a polymer resin. As shown in FIG. 8D, the glass stop may comprise an inner edge 523 that is used to define the opening occupied by the transparent pane, and an outer edge 525 that is adjacent to the sash stile or rail. As with the other building structures, the fiber-reinforced composite may comprise the entire body of the window part (FIG. 8D) or window frame part, or may provide a outer surface of cladding emplaced on a core.

Also, a fiber-reinforced composite window part, window frame, window frame part of the present invention may have color incorporated during production of the fiber-reinforced composite. In other embodiments, color may be applied to the fiber-reinforced frame or frame part subsequent to formation of the fiber-reinforced composite structure. Thus, color may be applied through painting and/or staining techniques known to those of skill in the art.

As described above, in an embodiment the present invention may provide cladding comprising a fiber-reinforced composite of the present invention. A fiber-reinforced composite cladding may comprise any desired length, width, thickness, and/or shape. In some embodiments, for example, a fiber-reinforced composite cladding may comprise cladding for door frames parts as described above, windows and window frame parts, rainscreen systems, ventilated facades, gables, eaves, facia boards, balcony lining panels, infill panels, soffits, and passageway linings. In some embodiments, the fiber-reinforced composite cladding of the present invention may comprise a color. As for other structural components comprising the fiber-reinforced composite, color may be incorporated into a fiber-reinforced composite cladding during the production of the fiber-reinforced composite or may be applied to the fiber-reinforced composite cladding subsequent to the formation of the cladding.

The present invention provides other building structures comprising a fiber-reinforced composite of the present invention. In an embodiment, a fiber-reinforced composite of the present invention may replace a prior art component, such as a panel, or a thin-layer component or supportive structure currently utilized in the building structures. The methods for producing such structures are generally known to those of ordinary skill in the art and can be adapted to using the composite material of the present invention with modification of such methods.

In another aspect, the present invention provides methods (or processes) for producing fiber-reinforced composites. The methods may be utilized to produce a fiber-reinforced composite building structure of the present invention. The methods may also be utilized to produce other types of composites or structural components.

In an embodiment, a method of the present invention comprises introducing a reinforcing fiber(s) and a polymer resin into a mold and curing the resulting resin mixture under conditions sufficient to produce a fiber-reinforced composite. The curing may be completely in the mold, or may be initiated in the mold and then completed upon removal of the structure from the mold. The reinforcing fiber and the polymer resin may be mixed prior to introduction to the mold, and/or during the step of introducing to the mold. The step of introducing the fiber and polymer resin to the mold may comprise dispensing the fibers and resin by injecting, spraying, pouring and/or similar techniques.

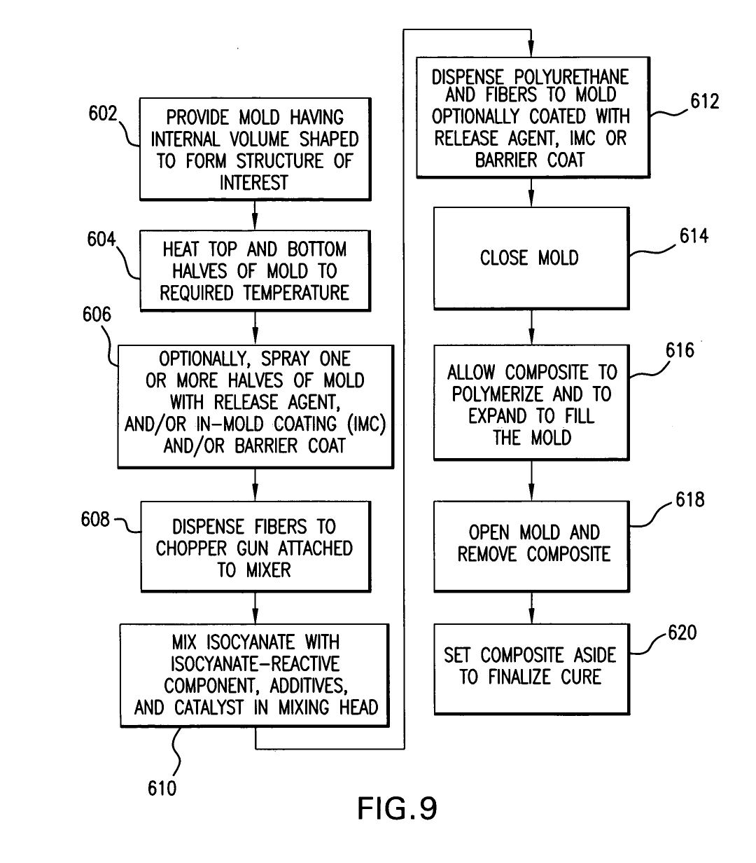

For example, in one embodiment, the present invention may comprise a method for producing a fiber-reinforced composite shaped into the form of a building structure comprising the steps of: preparing a mold having an internal volume in the shape of a building structure of interest; dispensing a mixture of fibers and a polymer resin into the mold; and allowing the resin to polymerize under conditions sufficient to produce a fiber-reinforced polymer composite. An embodiment of a method of the present invention as applied to the production of door skins is illustrated in FIG. 9. Thus, in one embodiment, the method may comprise a first step of preparing a mold that is shaped to form the building structure of interest, 602. For example, to make door skins, a die set comprising a first (e.g., lower) half and a second (e.g., upper) half may be used. The mold may be heated to the temperature that is required for polymerization to occur at a suitable rate, 604. For a polyurethane-based composite, the mold may be heated to a temperature in the range of about 120° F. to 190° F. (49° C. to 88° C.). For example, the mold may be heated by means of a hot water or oil heating system. In an embodiment, the top and bottom sections of the mold may be heated together or separately. Also, the top and bottom sections of the mold may be heated to the same temperature or to different temperatures. The mold may be shaped to provide molding or fluting for the structure. Also, a surface of the mold may be polished to a smooth finish or etched with a grain pattern. As described in more detail below, one or both mold halves may be coated with a release agent, a coating, and/or a barrier coat, 606.

Once the mold has been prepared, the reinforcing fibers may be provided to a chopper gun 608 for chopping the fiber to a required size to make the composite. Also, the components used to make the polymer may be mixed together, 610. In an embodiment, the apparatus used to introduce the fibers and resin onto the mold may comprise a mixing head and a dispenser. For example, in one embodiment, liquid polyurethane components, including an isocyanate and an isocyanate-reactive compound (e.g., an isocyanate-reactive polyol), and if necessary, additional additives (e.g., colorant, release agent, catalyst, foaming agent) may be mixed together in the mixing head, 610. At this point, the chopped fibers and mixed resin components may be dispensed onto at least one surface of the mold, 612. In one embodiment, the fibers and resin may be mixed together and then dispensed onto the mold by spraying or pouring the coated fibers onto the mold. Or, the fibers and resin may be mixed during the process of dispensing both onto the mold surface. In yet another embodiment, the fibers may be dispensed onto the mold surface and then the resin added. The mixing head and/or dispenser may be mounted on to a robot that is programmed to move over the open mold while dispensing both the long glass fibers and the polyurethane in an open pour or spray method, 612. In some embodiments, dispensing the fibers and resin may take from about 5 seconds up to about 2 minutes.

Once the fibers and resin have been dispensed, the mold may be closed, 614. At this point, the polymer resin may be allowed to polymerize or “cure” in the mold, 616. In an embodiment, the composite is partially cured in the mold. For example, in alternate embodiments, the composite may be greater than 50% cured while in the mold (i.e., prior to removing from the mold), or greater than 60% cured while in the mold, or greater than 70% cured while in the mold, or greater than 80% cured while in the mold, or greater than 90% cured while in the mold, or greater than 95% cured while in the mold. For example, removing the part from the mold before it is completely cured may allow the part to be re-molded to a slightly different shape. Once the structure has cured to the extent desired, the mold may be opened, and the composite removed, 618. In an embodiment, the composite may be set aside to finalize the cure step, 620.

The reinforcing fiber(s) component used in the methods of the present invention may comprise a single fiber type or a plurality of fiber types. The fiber may comprise a natural or a manmade fiber. Suitable fibers include, but are not limited to, glass fibers, mineral fibers, natural fibers such as wood, flax, jute, or sisal fibers, and/or synthetic fibers, such as polyamide fibers, polyester fibers, carbon fibers or polyurethane fibers. In an embodiment, the fibers are fiberglass. In an embodiment, the fiberglass comprises Electronic glass (or E-glass).

In an embodiment, long fibers are used as the reinforcing fiber. As used herein, a long fiber reinforced resin comprises a resin that contains reinforcing fibers that are long enough such that they generally cannot be processed efficiently using a conventional high pressure mixing head. The long fibers may be introduced into a polymer resin by LFI as is known by those of skill in the art.

In an embodiment, the fibers may have a length of greater than 1 mm (0.04 inches). In alternate embodiments, the fibers may have a length in the range of about 5 mm to 100 mm (0.2 to 3.9 inches). In alternate embodiments, the fibers may range in length from about 10 mm to 70 mm (0.4 to 2.8 inches), or from 30 mm to 50 mm (1.2 to 2 inches).

The resin component in a method of the present invention may comprise a thermosetting polymer resin. In an embodiment, the resin may comprise polyurethane. Alternatively or additionally, phenol formaldehyde, resorcinol formaldehyde, cross-linked polyesters, or other thermoset polymers may be used. As set forth above, polyurethane generally comprises a polyisocyanate polyadduct obtainable by reacting a polyisocyanate with an isocyanate-reactive compound such as a polyol, amine, and/or water. In other embodiments, polyurethanes may be synthesized using mixtures of diamines and diols. In further embodiments, polyurethanes may be synthesized using mixtures of diamines.

The isocyanates used in the methods of the present invention may comprise (cyclo)aliphatic and/or aromatic polyisocyanates. For example, aromatic diisocyanates, such as, diphenylmethane diisocyanate (“MDI”) and toluene diusocyanate (“TDI”) such as 2,4-touluene diisocyanate and 2,6-toluene diisocyanate may be used. In some embodiments, aromatic diisocyanates such as naphthalene 1,5-diisocyanate may be used.

A variety of isocyanate-reactive compounds may be used in the methods of the present invention. For example, suitable isocyanate-reactive compounds include compounds that comprise two or more reactive groups selected from OH, SH, NH, NH₂ and CH-acidic groups, such as β-diketo groups. As discussed above, examples of compounds that may be used to form polyurethanes include polyether-polyamines and/or polyols selected from the group of polyether polyols, polyester polyols, polythioether polyols, polyesteramides, hydroxyl-containing polyacetals, and hydroxyl-containing aliphatic polycarbonates, or mixtures of at least two of these polyols.

In some embodiments, diols may be utilized in the synthesis of polyurethanes by the methods of the present invention. Diols may comprise, for example, ethylene glycol, 1,4-butanediol, 1,6 hexanediol, and/orp-di(2-hydroxyethoxy)benzene. In some embodiments, diamines including diethyltoluene-diamine, methylenebis(p-aminobenzene), and/or 3,3′-dichloro-4-4′-diaminophenyl-methane, for example, may utilized in the synthesis of polyurethanes.

Additionally, in some embodiments, polyurethanes may comprise any desired degree of crosslinking. In some embodiments, for example, isocyanates may react with urethane groups of different polyurethane chains to form allophanate crosslinks. In other embodiments, isocyanates may react with urea groups from different polyurethane chains to form biuret crosslinks. In some embodiments, isocyanates may react with urethane groups on a first polyurethane chain and urea groups on a second polyurethane chain to produce both allophanate and biuret crosslinks. Isocyanates, in some embodiments, may trimerize to form isocyanurates, which may serve as a source of crosslinking in polyurethanes.

One advantage of using thermoset resins such as polyurethane in the methods of the present invention, is the reduced levels of Volatile Organic Compounds (VOCs) that are emitted during the manufacture of such composites as compared to composites manufactured from other resins such as polyester and the like. Polyurethane is styrene-free, thus emission of VOCs is essentially eliminated. In an embodiment, a method of the present invention has a VOC emission of less than 0.1 ppm during manufacture. In another embodiment, the method of the present invention has a VOC emission of less than 0.05 ppm during manufacture. In yet an alternate embodiment, the method of the present invention has a VOC emission of less than 0.01 ppm during manufacture.

The reaction may proceed in the presence or absence of a blowing agent, catalyst, auxiliary or additive. In an embodiment, a method of the present invention may further comprise introducing a blowing agent into the mold. The blowing agent, fiber(s) and polymer resin may be mixed prior to, during, and/or after introduction to the mold. The amount of blowing agent used is guided by the target density of the foams.

In an embodiment, the method may further comprise introducing a catalyst into the mold or resin mixture. The catalyst may be mixed with the other ingredients (fiber(s), resin, etc.) prior to, during, and/or after introduction to the mold. Any number of catalysts may be used. For polyurethane formation, suitable examples include tertiary amines and/or organometallic compounds. Examples of compounds which may be used as catalysts include the following: triethylenediamine, aminoalkyl- and/or aminophenylimidazoles, e.g. 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole; tin(II) salts of organic carboxylic acids, examples being tin(II) diacetate, tin(II) dioctoate, tin(II) diethylhexoate, and tin(II) dilaurate; and dialkyltin(IV) salts of organic carboxylic acids, examples being dibutyltin diacetate, dibutyltin dilaurate, dibutyltin maleate and dioctyltin diacetate.

In an embodiment, the method may further comprise introducing additional components, such as cell regulators; surface-active compounds such as release agents, barrier coats, or other types of coating; pigments and/or other types of colorants; and/or stabilizers to counter oxidative, thermal or microbial degradation or aging, into the mold. The additional component may be mixed with other ingredients prior to, during, and/or after introduction to the mold.

In an embodiment, the method further comprises introducing a filler into the mold. The filler may be mixed with the fibers or the resin components (or additives) prior to, during, and/or after introduction to the mold. The filler may be sized or un-sized. The filler may be modified to have improved free-flow properties and adhesion to the polyurethane matrix. In an embodiment, the filler may comprise platelet-shaped fillers such as glass flakes and/or minerals such as mica.

Also, the method may further comprise introducing a colorant into the mold. The colorant may be mixed with other ingredients prior to, during, and/or after introduction to the mold. Suitable colorants include but are not limited to, titanium dioxide, calcium sulfate, manganese dioxide, carbon black, or other appropriate pigments as set forth herein with reference to a fiber-reinforced polymer composite of the present invention.

The curing step of a method of the present invention may be performed in a manner as is generally known to those of ordinary skill in the molding art. Curing may be initiated in the mold and completed in the mold or after removal from the mold. Generally, the resin mixture is maintained at a temperature and pressure sufficient to at least partially cure the mixture and form a self supporting composite prior to removal from the mold. After removal, further curing and/or shaping may take place.

Thus, to cure the composite, once the resin and fibers are distributed onto the mold surface, the mold may be closed. In another embodiment, a mold that is at least partially open during the cure step may be used. The polymerization may then allowed to proceed in the mold under conditions such that at least a portion of the blend polymerizes. In an embodiment, the structure is allowed to remain in the mold until polymerization is substantially complete and the part has cooled. Or, the part may be removed at or shortly after peak exotherm, and formed to a different shape (i.e., such as an arch shape or the like).

The temperature and pressure at which curing takes place may vary depending upon the polymer being used, the part being made, production considerations, and the like. In alternate embodiments, the resin mixture may be cured at a temperature of from 100° F. (38° C.) to 400° F. (204° C.), and a pressure of from 20 psi (1.41 kg/cm²) to 1,500 psi (106 kg/cm²), for a period of from about 15 seconds to 600 seconds. In another embodiment, the resin mixture may be cured at a temperature of from 120° F. (49° C.) to 300° F. (149° C.), and a pressure of from 20 psi (1.41 kg/cm²) to 1,000 psi (70.3 kg/cm²), for a period of from 25 seconds to 300 seconds. Or, the resin may be cured at a temperature of from 130° F. (54.4° C.) to 200° F. (93.3° C.), and a pressure of from 30 psi (2.1 kg/cm²) to 500 psi (35.1 kg/cm²), for a period of from 30 seconds to 180 seconds.

A method of the present invention may be advantageously utilized to produce a fiber-reinforced polymer composite structure for a particular end use. In an aspect, the present invention provides methods and systems for producing a fiber-reinforced polymer composite comprising fiber-reinforced polyurethane for use as a part of a building structure.

In an embodiment, the method comprises a mold having a first half for pressing the composite having a surface with outer dimensions suitable for forming the building structure of interest, and a second half for pressing the composite having a surface with substantially the same outer dimensions as the first half. The shape of the mold may be varied depending upon the building structure that is to be made.

For example, the mold may be designed to manufacture door skins. Thus, in an embodiment, the method may comprise a method to manufacture door skins comprising the steps of: preparing a mold comprising a first and second die, where both dies comprise at least one substantially planar surface; dispensing a mixture comprising a plurality of fibers and a polymer resin onto the substantially planar surface of one of the dies; bringing the second substantially planar surface of the second die in contact with the fibers and resin; and allowing the resin to polymerize under conditions sufficient to produce a fiber-reinforced composite in the shape of a door skin.

In one such embodiment, the first half of the mold comprises a female die having a surface comprising at least one depression and the second half of the mold comprises a male die that has a protrusion matching the depression on the first die, such that when the mold is closed, the protrusion on one dies is substantially aligned with the depression on the other die. Or, the die surfaces may be flush so that there are no protrusions or depressions on either die. Where the system is used to manufacture door skins, a pattern or a smooth surface may be formulated on the door skin surface. Thus, in an embodiment, at least a portion of one of the two dies may be polished to a smooth finish. Alternatively or additionally, at least a portion of one of the two dies may comprise a pattern etched in the surface. For example, in an embodiment, the pattern may simulate a wood grain. In an embodiment, the outer dimensions of the first and second die halves are sufficient to produce door skins having the dimensions set forth herein. Generally, the outer dimensions of the first and second die halves are less than about 107 inches (272 cm) in length by about 48 inches (122 cm) in width. Although almost any dimension is possible with the method of the invention, the size of the composite may be limited by the machinery used to make the part.

Also as described herein, the mold or die surface used to form the fiber-reinforced polymer composite may be sprayed or otherwise treated with a release agent prior to introducing fiber(s) and resin into the mold. Or, a release agent may be included as part of the resin. Typical compounds that may be used as a release agent include wax-based or silicone-based release agents.

Or, the mold may be treated with an in-mold coating (IMC) prior to introducing material into the mold. Typical agents that may be used for IMC include, but are not limited to aliphatic urethanes, acrylics, alkyds, and the like.

Alternatively or additionally, a barrier coat may be applied to the surface of a mold prior to introducing the fiber and resin into the mold. A barrier coat may be advantageous for enhancing the surface characteristics of the composition. For example, a barrier coat may be utilized to create a surface substantially free of pits, bubbles, fibers or fiber pieces/ends, that in certain processes may be created on a surface of the fiber-polyurethane mixture. The barrier coat may comprise an elastomer, or a non-elastomeric resin, a thermoset resin, a thermoplastic resin or the like. Examples include, but are not limited to, acrylic resins, polyolefins and other thermoplastics, polyurethane, phenol formaldehyde and other thermosets, and the like. In certain embodiments it may be advantageous to utilize a barrier coat that mechanically or chemically binds to the fiber-polyurethane mixture during molding or curing. Examples of barrier coats include BAYDUR® resins (Bayer MaterialScience, LLC), PLIOGRIP® (Ashland Specialty Chemical), Devcon 309 Methacrylate (ITW Devcon).

Polymerization of the resin (e.g. polyurethane) from the appropriate starting materials may be controlled by controlling the temperature of the reaction. Thus, in an embodiment, at least one of the dies comprises a temperature controller, and the method further comprises controlling the temperature of the mold.

The thickness and/or density of the final fiber-reinforced polymer composite product may depend in part upon the overall expansion of the polymer upon polymerization and the extent to which the polymer is allowed to foam. In an embodiment, the inner surfaces of the mold are separated by a predetermined distance when the mold is closed. For example, when the method is used to make door skins, the internal surfaces of the mold may be spaced apart by 1.0 to 0.05 inches (25.4 mm to 1.27 mm). In alternate embodiments, the dies may be separated by a distance in the range of from about 0.8 to 0.08 inches (20.3 mm to 2.0) when the die is closed, or from about 0.5 to 0.1 inches (12.7 mm to 2.54 mm) when the die is closed, or from about 0.15 to 0.11 inches (3.81 mm to 2.79 mm) when the die is closed.

In an embodiment, the present invention provides methods of making building structures (e,g., headers, jambs, sashes, and stiles) that are not thin-layered structures. For example, to make door jambs and window sills that may have the entire structure, or a substantial portion thereof, comprising the fiber-reinforced polymer of the present invention, components used to make the polymer (e.g., an isocyanate and an isocyanate-reactive compound) may be mixed, and the mixture poured into a mold having an internal volume that comprises the door frame part of interest. Or, the mold may be designed to manufacture plant-on structures for doors. Or, the mold may be designed to manufacture window parts or window frame parts. Or, molds designed to manufacture siding, shutters, and/or shingles may be used. Generally, the methods of the present invention may be used with standard molds that are used to manufacture the building part of interest. In one embodiment, the mold may comprise fluting or other decorative shaping. Where such additional shaping is included, the polymer layer at the surface will include the additional shaping.

In an additional aspect, the present invention provides a system for manufacturing a fiber-reinforced composite. The system may comprise an introducing apparatus and a mold. In an embodiment, the mold may be shaped to form a building structure. The introducing apparatus may comprise a mixer for mixing at least two components used to make a polymer resin (e.g., a mixing head). The apparatus may further comprise a chopper for chopping the fiber to a predetermined length. Also, the introducing apparatus may comprise a dispenser for dispensing the fibers and the resin onto a surface of the mold. In one embodiment, the dispenser may comprise a sprayer. Or, the dispenser may comprise an injector. Or, the dispenser may pour the fibers and/or resin onto the mold. The mixer and dispenser may be located in a single component of the introducing apparatus. The introducing apparatus may further comprise conduits for providing resin components and/or other additives to the mixing head. Also, the introducing apparatus, or part thereof, may be moveable to position the dispenser adjacent to different portions of the mold.

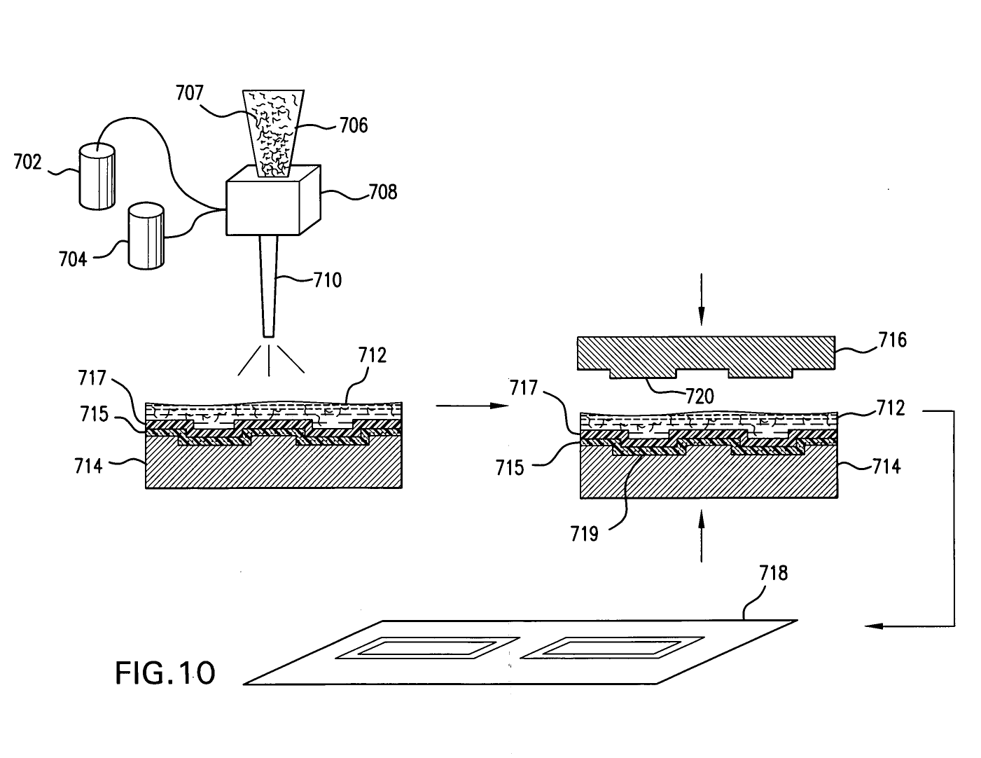

An embodiment of a system of the present invention is illustrated in FIG. 10. In an embodiment, the system may be adapted for the preparation of fiber-reinforced polymer composites by long-fiber injection (LFI) technology. Thus, the system may comprise an open mold, comprising a first half 714 and a second half 716, shaped to contain a fiber-reinforced polymer composite having the required dimensions. In one embodiment, where the building structure comprises a door skin, the open mold may comprise a die set having a first die and a second die. The mold may be heated to the temperature required for polymerization of the polymer resin. For example, the mold may be heated by means of a hot water or an oil heating system. In an embodiment, the top and bottom sections of the mold are heated separately. Also, the surface of the mold in contact with the fiber-resin mixture may be polished to a smooth finish, or etched with a grain pattern. Also, to facilitate removal of the structure from the mold, one or both mold halves may be coated with an IMC, 715, a barrier coat 717, or some other type of coating (FIG. 10).

As described above, the system may also comprise a robotically controlled mixing head 708 for mixing a first resin component 702 and a second resin component 704 and injecting the mixture into the mold. In one embodiment, the first resin component 702 may comprise an isocyanate component and the second resin component 704 may comprise an isocyanate-reactive component. The system may further comprise conduits 703, 705 for introducing the first and second resin components into the mixing head. The system may further comprise a glass chopper 706 functionally connected to the mixing head. The system may further comprise dispenser 710 (e.g., an injector or sprayer) that functions to distribute fibers along with the mixed resin onto a part of the mold. In an embodiment, the mixing head functions to mix fibers in with the resin components. Alternatively, the chopped fibers may be distributed onto the surface of the mold prior to being coated by the resin mixture. Or, the fibers and the resin may be mixed during the step of dispensing both to the mold. The dispenser 702 and mixing head 708 may be mounted on to a robot that is programmed to move over the open mold 714 while dispensing the mixture comprising long glass fibers and the polymer resin 712 to the mold.

As described above, to facilitate removal of the fiber-reinforced composite (e.g., door skin) from the mold, a release agent may be applied to the composite or to the mold. In an embodiment, the release agent may be included as part of the resin mixture (i.e., as an internal release agent). For the internal release agent, the release agent may comprise compounds such as wax-based or silicon-based release agents used in the door skin manufacturing industry. Alternatively or additionally, an in-mold coating (“IMC”) 715 may be sprayed on the surface of the mold. In an embodiment, the IMC may comprise a release agent such as those described above, or an anti-bonding agent known in the art of pressing composites as being effective in preventing polymer composites from sticking to dies or mold surfaces, such as silicones and the like. Or the IMC may comprise a pigment. In yet another embodiment, the IMC may comprise a barrier coating. Alternatively or additionally, a barrier coat layer 717 may be applied to the surface of the die, or onto the IMC 715 previously been applied to the surface of the mold.

Once the mixture has been applied to the first part of the mold 714 (e.g., bottom) the second half of the mold 716 (e.g., top) may be lowered (i.e., the mold is closed) and the fiber-reinforced composite is formed as the resin components polymerize. Where the resin is polyurethane, the polymer may experience some foaming, and expand to fill the mold. After a few minutes, the reaction may be substantially complete such that the mold may be opened and the structure removed. The resulting fiber-reinforced composite 718 (e.g., door skin) may be set aside to finalize curing.

The mold may be shaped to form a building structure of interest. In one embodiment, the mold may comprise two dies shaped to press a door skin. The mold may be shaped such that the door skin comprises panels. For example, in an embodiment, the first die comprises a female die having a surface comprising at least one depression 719 and the second die comprises a male die have a protrusion 720 substantially matching the depression on the first die such that the final door skin may comprise a panel as shown in FIGS. 1 and 2. The door skin may be smooth, or it may have a pattern designed to simulate a wood grain. To make a door skin having a smooth surface, at least one of the dies may be polished to a smooth finish. To make a door skin having a surface that resembles a wood grain, at least one of the two dies may comprise a pattern etched in the surface.

The mold may comprise a means to control the temperature of the polymerization as the polymerization occurs in the mold. Where the mold comprises dies to shape door skins, at least one of the dies may comprise a means for controlling the die temperature.

The mold may comprise a commercially available mold standard in the art. As described herein, the mold should be able to exert pressure on the product as required. The surface of the mold may comprise steel, aluminum, enamel, Teflon, Epoxy resin, or other polymer material. The mold surface may be chromium plated as for example, by hard chroming. In an embodiment, the surface of the mold may be polished. In an embodiment, the mold is temperature controlled so that the temperature may be set to maximize flow and curing of the fiber-filled polyurethane. For example, the reaction of polyisocyanate to form polyurethane normally is conducted at a mold temperature from 30° C. to 90° C. (86° F. to 194° F.). For example, in an embodiment, the mold is heated using a hot water or oil heating system.

The mold may be designed as required by the building structure that is being made. Thus, in an embodiment, the dies are separated by a predetermined distance when the mold is closed. For example, the application of LFI technology to door skins is associated with the manufacture of very thin structures. Thus, for the case of the manufacture of thin-layer composites such as panels, cladding, or door skins, the dies may be separated by a distance in the ranges of from about 1.0 to 0.05 inches (25.4 mm to 1.3 mm) when the die is closed. In alternate embodiments, the dies may be separated by a distance in the range of from about 0.8 to 0.08 inches (20.3 mm to 2.0) when the die is closed, or from about 0.5 to 0.1 inches (12.7 mm to 2.5 mm) when the die is closed, or from about 0.15 to 0.11 inches (3.8 mm to 2.8 mm) when the die is closed. Further details of methods of the present invention and systems of the present invention are set forth below with reference to particular embodiments.

Thus, as set forth herein, an embodiment of the present invention comprises a fiber-reinforced composite comprising polyurethane and fiberglass for use in building structures. The use of fiberglass as part of a fiber-reinforced polymer composite has been described in the art of door manufacture. For example, U.S. Pat. Nos. 5,074,087 and 5,075,059 describe doors made with door skins made from a compression molded fiberglass polyester resin using molds that may impart a wood grain pattern to the outer surface of the door skin. Also, U.S. patent Publication No. 2003/0226383 describes fiberglass door skins prepared from a molding compound that when molded has a predefined shrinkage.

Still, these and other fiberglass door skins known in the art comprise polyester-fiberglass skins made using SMC or Bulk Molding Compound (“BMC”) technology. SMC is a fiberglass reinforced thermosetting or thermoplastic compound that is prepared in sheet form and rolled into coils that are then interleaved with plastic film to prevent auto-adhesion. The SMC pre-mix may be made from glass strands chopped to lengths of 25 or 50 mm, onto which the resin paste is applied. In some cases, the pre-mix passes through a compaction system that ensures complete strand impregnation before the SMC is wound into rolls. The SMC mat may be formed by dispensing mixed resin, fillers, a maturation agent, a catalyst, and a release agent onto two moving sheets of polyethylene film that contains the chopped glass roving or mat. The SMC pre-mix is generally stored for a few days before molding the mat into the desired shape to allow the pre-mix to thicken to a moldable viscosity. SMC requires a thermoplastic resin, so that the sheet may be pre-formed and then molded into the final configuration.

In contrast, the present invention describes the use of a thermoset polymer resin, such as polyurethane, for the manufacture of fiber-reinforced fiber-reinforced polymer composites. For example, in an embodiment, the invention comprises the manufacture of thin-layer polyurethane fiberglass composites for use as door skins and other building structures. Also, as described herein, the fiber-reinforced composites of the present invention may be used for door frame parts, window parts, siding, and the like. The advantages of polyurethane thin-layer fiber-reinforced polymer composites are many, but include reduced emissions of VOCs and the ability to make a product having controlled density with improved linear thermal expansion properties.

In embodiments of either a method or a system of the present invention, Long Fiber Injection (LFI) technology may be used to form a polyurethane composite comprising long fiber reinforcing fibers. In an embodiment, the long fibers are glass, such as Electronic glass (i.e., E-glass) or the like. For LFI, a glass chopper gun may be attached to a mixing head used to introduce resin and fiber into a mold. The mixing head and chopper may be mounted on a robot that is programmed to move over the open mold while dispensing both the long glass fibers and the mixed polyurethane components in a spray or open pour method. The nature of the surface of the fiber-reinforced polymer composite will be determined in part by the mold used to shape the composite. At the end of the spray or pour, the may be mold closed to form the part.

Further details and advantages of the present invention will be apparent from the following examples.

### EXAMPLES

The following examples describe particular embodiments of fiber-reinforced composites of the present invention and particular embodiments of methods and systems of the present invention.

Fiberglass Reinforced Polyurethane Panels and Door Skins

In an embodiment, the fiber-reinforced composite of the present invention is a door skin or a panel such as may be used for a wall or door unit. In an embodiment, the door skin or panel comprises lips that can at least partially wrap around the frame of the structure to be covered. For example, the lips may wrap around the rails and/or stiles used to make the door frame. The lips may be sized to completely overlap one another. Alternatively, the door skin or panel may be flat with square edges.

Door skins having a six panels such as that shown in FIG. 1 were made with the fiber-reinforced composite of the present invention. Thus, as shown for the door skin of FIG. 1, in an embodiment, the door skins of the present invention may comprise molded panels. For example, in an embodiment the door skin may comprise 0 to 15 panels, using panel designs known in the art. The molding detail of the door skins may be greater than 90 degrees from the surface and may be above and/or below the surface. The door skin may have openings for light inserts (e.g., translucent panels or windows) to be installed in the door as integral to the door or installed after the door is assembled.

In an embodiment, the door skin comprises a composition of 10%-60% fiberglass, 40%-90% polyurethane, 0-8% additives such as colorants, UV stabilizers and fire retardants. For example, a fiber-reinforced composite door skin having a mixture of 40% fiberglass and 60% polyurethane was prepared using the methods and systems of the present invention as described below in Example 2.

Also, a release agent may be used in the manufacture of the door skins of the present invention. The release agent may be internal to the door skin, usually in concentrations of about up to 2%, or the release agent may be applied to the external surface of the door skin in the same concentrations. Examples of compounds that may be used as release agents include the release agents described herein.

Alternatively or additionally, a coating may be applied to the door skin via in-mold coating (IMC) applications (i.e., applied to a die surface prior to application of the fiberglass and urethane). Examples of compounds that may be used as an IMC include pigmented aliphatic urethanes, acrylics, alkyds, or other coating with acceptable performance and appearance.

Alternatively and/or additionally, a barrier coat, as described herein, may be applied to the door skin. This barrier coat may be located between the IMC and the door skin or directly on the door skin without the IMC. A barrier coat may be added via spray, curtain coat, or other application systems known in the art. Examples of barrier coats include BAYDUR® resins (Bayer MaterialScience, LLC), PLIOGRIP® (Ashland Specialty Chemical), Devcon 309 Methacrylate (ITW Devcon). For example, the door skins made comprising 40% fiberglass and 60% polyurethane as described above using the methods and systems of the present invention as described in Example 2 also contained a barrier coat layer of 0.008 inches BAYTEC® 156 (Bayer Chemical Company) and an IMC layer of 0.003 inches of an aliphatic polyurethane (Titan).

The door skins of the present invention may be thin-layered composites. Generally, the door skin is a flat sheet that may be as large as 97 inches (2.46 m) in length by 49 inches (1.24 m) in width, or as small as 60 inches (1.52 m) in length by 9 inches (0.23 m) in width. Also, the door skin is generally less than 0.130 inches (3.30 mm) in thickness. In some embodiments, the door skin is less than 0.09 inches (2.29 mm) thick. For example, the fiber-reinforced door skins made using the methods and systems of the present invention had dimensions of 36.25 inches by 80.5 inches (921 mm by 204 cm). Still, other sizes may be manufactured using the methods and systems of the present invention depending on the use for the final products.

The door skins of the present invention may comprise a reduced density as compared to fiber-filled SMC door skins of the prior art. In an embodiment, the door skins of the present invention may have a density that ranges from about 20 pcf to 110 pcf (or about 320.4 to 1762 kg/m³). In other embodiments, the fiber-reinforced polymer composite door skins of the present invention may have a density of from about. 30 pcf to 100 pcf (or about 480.6 to 1602 kg/m³), or alternatively, from 35 pcf to 95 pcf (or about 560.7 to 1522 kg/m³). For example, the fiber-reinforced door skins made using the fiber-reinforced composite of the present invention had a measured density of 78 pcf (1250 kg/m³).

Also, as described above, the door skins of the present invention may comprise improved thermal stability as compared to wood door skins. For example, the door skins made using the methods of the present invention may have a coefficient of thermal expansion of about 15×10⁻⁶ mm/mm/° C.).

Also, the door skins of the present invention may comprise improved elastic properties. For example, in an embodiment, door skins made using the methods of the present invention comprise a modulus of elasticity of about 280 Kpsi (or about 19,691 kg/cm). Thus, the fiber-reinforced composite door skins of the present invention may be stiff enough to be handled without problems, but not so stiff as to warp the door when the skins change dimensions due to temperature differentials. Additionally, in an embodiment, the LFI skins of the present invention have good resistance to water absorption and loss using tests standard in the industry.

Also, in an embodiment, the fiberglass door skins of the present invention comprise levels of swelling and shrinking upon exposure to very wet or dry conditions, respectively (e.g., a 24 hour water soak; a 24 hour oven dry; a 72 hour exposure to 93% humidity; and/or a 1 hour boil) that compare favorably to doorskins made using wood-based composites.

By their nature, door skins provide a large surface area that is exposed to the environment. Thus, emission of volatile organic chemicals (VOCs) during manufacture can be a concern. Because the door skins of the present invention are made using polyurethane as opposed to polyester and other resins typically used in the art, the door skins are essentially styrene-free. Thus, there can be a significant reduction in VOC emission-as compared to fiber-filled door skins made using SMC resins.

Production of Thin-Layer Fiber-Filled Polyurethane Composites

FIG. 10 shows a schematic representation for using LFI for the production of a fiber-filled polyurethane composite by LFI, such as a thin-layer door skin. Thus, as shown in FIGS. 10, an open mold, or die set, comprising a first half 714 and a second half 716, shaped to contain a fiber-reinforced polymer composite having the required dimensions may be used. The mold is heated to a temperature of about 120 to 190° F. (49° C. to 88° C.), by means of a hot water or oil heating system. In an embodiment, the top and bottom sections of the mold are heated separately, each to a temperature in the range of about 120 to 190° F. (49° C. to 88° C.). The individual surfaces of the mold may be polished to a smooth finish or etched with a grain pattern. Optionally, one or both mold halves may be coated with a release agent, in-mold coating, and/or barrier coat. Reinforcing fiberglass fibers, 707 are provided to a chopping gun 706 for introduction onto a surface of the mold (i.e., the lower die). The liquid components used to make the polymer resin, 702 and 704, may include (A) an isocyanate (e.g., 702), and (B) an isocyanate-reactive compound (e.g., 704), as for example, known isocyanate-reactive polyols commercially available in the art, such as, but not limited to, Elastoflex E130-002 from BASF (Mount Olive, N.J.) or BAYDUR® products from Bayer. If necessary, additional additives (e.g., a colorant, a release agent, a catalyst, a foaming agent, or a fire retardant) may be included as part of either one of the resin components (e.g., A or B) such that polymerization may occur upon mixing the reactive components (e.g., A and B). Once the two resin components and any additives are mixed together, the resin mixture is applied as a stream with the chopped fiberglass 707 to the mold. In an embodiment, the resin and fiberglass are mixed as they are introduced into the stream. Generally, the fiberglass is chopped to about 0.5 inch or greater in length (Electronic Glass; e.g., Owens Corning or Gibson Fiberglass). The fiberglass-resin stream is then applied to the mold. In an embodiment, the process of applying the LFI mixture to the mold is performed using a LFI-PUR® unit (Krauss Maffei; U.K.) developed for this process. The LFI-PUR® unit comprises a glass chopper gun 706 that chops the fiberglass and that is attached to a mixing head 708. The mixing head is mounted on to a robot that is programmed to move over the open mold 714 while dispensing both the long glass fibers and the polyurethane 712 in an open pour or spray method. Depending on the application, the pour time may take from about 5 seconds up to about 2 minutes.

As described above, to facilitate removal of the door skin from the mold, a release agent may be applied to the skin or to the mold. In an embodiment, the release agent is included as part of the polyurethane mixture (i.e., as an internal release agent). For the internal release agent, the release agent may comprise compounds, such as wax-based or silicon-based release agents, used in the door skin manufacturing industry.

Alternatively or additionally, an in-mold coating (IMC) 715 may be sprayed on the surface of the mold. In an embodiment, the in-mold coating may comprise an anti-bonding agent known in the art of pressing composites as being effective in preventing polymer composites from sticking to dies or mold surfaces, such as aliphatic urethanes and the like. Also, the IMC may comprise a pigment for coloring the surface of the door skin.

Alternatively or additionally, a barrier coat 717 may be applied to the surface of the die, or onto the IMC 715 which has previously been applied to the surface of the mold. The barrier coat may be any material that improves properties and/or appearance of the door skin, such as BAYTEC® SPR-156D from Bayer.

Once the mixture has been applied to the bottom die half 714, the top (e.g., male) die 716 may be lowered (i.e., the mold is closed) and the polyurethane/fiberglass composite is formed by crosslinking of the isocyanate-polyol mixture. In LFI, the polyurethane will experience some foaming, and expand to fill the mold. After about 0.5 to 3 minutes, the reaction is substantially complete and the mold may be opened and the door skin 718 may be removed. The resulting fiber-reinforced composite may be set aside to finalize curing.

The entire LFI cycle to form one door skin may take approximately 2 to 5 minutes. After each cycle the injection head is cleaned with an organic solvent, steam, or other solvent to prevent extraneous polymerization and/or fiber build-up.

After the fiber-reinforced composite has been formed by LFI, it is allowed to cure. The majority of the curing may take place inside the mold, such that once removed from the mold, the molded composite may be set aside to complete the reaction. For example, in an embodiment, a fiber-reinforced polymer composite may be at least 80% cured in the mold, with the remainder of the curing taking place by allowing the composite to sit for about an hour at room temperature. Or, the part may be re-molded after removal from the die set, as for example where the thin-layer composite is used to make non-planar, thin-layer cladding for a door or window part. In an embodiment, the fiber-reinforced polymer composite may be further treated. For example, in an embodiment, the fiber-reinforced polymer composite may be painted on the outside surface.

Thus, the present invention provides methods and compositions relating to the production of fiber-filled polyurethane composites for use in building structures. Embodiments of the present invention offer a wide variety of advantages and features. For example, one advantage of the present invention is to provide fiber-reinforced composites made of fiber-reinforced polyurethane that comprise one or more improved structural characteristics such as improved tensile strength, impact resistance, good insulating ability, resistance to thermal-induced shrinking and swelling, and reduced density/lower weight.

Also, one advantage of the present invention is to provide fiber-reinforced composites made of fiber-reinforced polyurethane that comprise reduced emission of VOCs as compared to fiberglass fiber-reinforced polymer composites made by methods previously known in the art. Because the polyurethane/fiberglass composites are styrene-free, the VOCs are significantly reduced, if not nonexistent.

In addition, the LFI process used for the fiber-reinforced composites of the present invention is essentially a one-step process. Thus, there is no need to add the polyurethane mixture to a mat of fibers as is done in SMC based technology. Also, the closed nature of the process can significantly reduce the amount of glass fibers emitted into the workplace environment.

Yet another advantage of the present invention is the ability to control the density and also, the flexibility of the resultant fiber-reinforced composite. In an embodiment, the door skins comprise a lower weight and reduced density as compared to door skins made using SMC based technology. One reason for the lighter weight of the polyurethane-based composites of the present invention is because air acts as a foaming agent. Also,, the door skins may be formulated to have decreased density as compared to door skins made using SMC technology by increasing the amount of polyurethane as compared to the fiberglass used for the composite. Alternatively, the door skins may be formulated to have increased density as compared to door skins made using SMC technology by decreasing the amount of polyurethane as compared to the fiberglass used for the composite. Similarly, the resultant flexibility of the fiber-reinforced composite may be adjusted by control of the relative levels of fibers, polyurethane crosslinking and foaming in the final product.

Yet another advantage is that because polyurethane actually bonds to the fibers, whereas polyester only encases the fibers, the present invention provides for use of a variety of fiberglass grades. For example, fibers used with polyester resins generally require a roughened surface to adsorb to the polyester. In the present invention, such roughened fibers are not necessary.

The fiber-reinforced composites of the present invention also have good mechanical properties. For example, in an embodiment, the fiber-reinforced composites of the present invention display high resistance to thermal-induced swelling and shrinking, and high resistance to heat-induced peeling and/or cracking. In addition, they provide improved resistance to denting or bending, and improved ability to be machined as compared to fiber-reinforced composites made with polyester resins.

Also, embodiments of the present invention may provide a fiber-reinforced composite that has a high resistance to scratching, but that may be painted to provide a surface that is aesthetically pleasing. Additionally, it is possible to include a primer or colorant as part of the IMC or barrier coat used to spray the mold. In this way, the skin may be primed or painted as part of the molding step.

Yet another advantage is the reduced capital cost in the equipment required for LFI as compared to SMC. Thus, the technology may be introduced on a small or large scale as required.

In addition, use of LFI allows for a higher percentages of fiber to be used. As the fiber is less expensive than the resin, this can result in significant cost savings and improved performance of the product.

It will be understood that each of the elements described above, or two or more together, may also find utility in applications differing from the types described. While the invention has been illustrated and described as systems and methods to prepare fiber-reinforced composites, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as described herein. All patents and published patent applications referred to in this document are incorporated by reference in their entireties herein.

1. A fiber-reinforced composite building structure comprising a fiber and a polymer resin.

2. The building structure of claim 1, wherein the polymer resin comprises a thermosetting polymer.

3. The building structure of claim 2, wherein the thermosetting polymer comprises polyurethane.

4. The building structure of claim 1, wherein the fiber comprises fiberglass.

5. The building structure of claim 1, wherein the fiber ranges in length from about 5 mm to about 100 mm.

6. The building structure of claim 1, wherein the fiber comprises a plurality of chopped fibers arranged in a non-structured, substantially random orientation.

7. The building structure of claim 1, further comprising a non-fiber filler.

8. The building structure of claim 1, further comprising a coloring agent.

9. The building structure of claim 1, further comprising at least one of a release agent, a barrier coat, or an in-mold coating applied to at least a portion of the structure.

10. The building structure of claim 1, further comprising a substantially planar structure.

11. The building structure of claim 10, wherein the structure comprises a door skin.

12. The building structure of claim 10, wherein the structure comprises a panel.

13. The building structure of claim 1, wherein the structure comprises cladding.

14. The building structure of claim 1, wherein the structure comprises a door frame or a portion of a door frame.

15. The building structure of claim 1, wherein the structure comprises a window frame part or a window part.

16. The building structure of claim 1, wherein the structure comprises siding.

17. The building structure of claim 1, wherein the structure comprises a shutter.

18. The building structure of claim 1, wherein the structure comprises a shingle.

19. A fiber-reinforced composite door skin comprising a fiber and a polymer resin.

20. The door skin of claim 19, wherein the polymer resin comprises a thermosetting polymer.

21. The door skin of claim 20, wherein the thermosetting polymer comprises polyurethane.

22. The door skin of claim 19, wherein the fiber comprises fiberglass.

23. The door skin of claim 19, wherein the fiber ranges in length from about 5 mm to about 100 mm.

24. The door skin of claim 19, wherein the fiber comprises a plurality of chopped fibers arranged in a non-structured, substantially random orientation.

25. The door skin of claim 19, further comprising a non-fiber filler.

26. The door skin of claim 19, further comprising a coloring agent.

27. The door skin of claim 19, further comprising at least one of a release agent, a barrier coat, or an in-mold coating applied to at least a portion of the structure.

28. The door skin of claim 19, further comprising a flat profile.

29. The door skin of claim 19, further comprising a molding.

30. The door skin of claim 19, further comprising an opening for a translucent panel.

31. The door skin of claim 19, further comprising a substantially smooth surface.

32. The door skin of claim 19, further comprising a grain pattern on at least one surface.

33. A door comprising the door skin of claim 19.

34. A door comprising a fiber and a polymer resin formulated as a fiber-reinforced composite.

35. The door of claim 34, wherein the polymer resin comprises a thermosetting polymer.

36. The door of claim 34, wherein the thermosetting polymer comprises polyurethane.

37. The door of claim 34, wherein the fiber comprises fiberglass.

38. The door of claim 34, wherein the fiber ranges in length from about 5 mm to about 100 mm.

39. The door of claim 34, wherein the fiber comprises a plurality of chopped fibers arranged in a non-structured, substantially random orientation.

40. The door of claim 34, further comprising a non-fiber filler.

41. The door of claim 34, further comprising a coloring agent.

42. The door of claim 34, further comprising at least one of a release agent, a barrier coat, or an in-mold coating applied to at least a portion of the structure.

43. The door of claim 34, wherein the fiber-reinforced composite comprises a door skin.

44. The door of claim 34, wherein the fiber-reinforced composite comprises a door panel.

45. The door of claim 34, wherein the fiber-reinforced composite comprises a plant-on structure.

46. The door of claim 34, wherein the fiber-reinforced composite comprises a cladding.

47. The door of claim 34, wherein the fiber-reinforced composite comprises an opening for a translucent panel.

48. The door of claim 34, wherein the fiber-reinforced composite comprises at least one substantially smooth surface.

49. The door of claim 34, wherein the fiber-reinforced composite comprises a grain pattern on at least one surface.

50. A method for producing a building structure comprising the steps of:
preparing a mold having an internal volume in the shape a building structure;
dispensing a mixture comprising a plurality of fibers and a polymer resin onto a surface of the mold; and
allowing the resin to polymerize under conditions sufficient to produce a fiber-reinforced composite.

51. The method of claim 50, wherein the polymer resin comprises a thermosetting polymer.

52. The method of claim 51, wherein the thermosetting polymer comprises polyurethane.

53. The method of claim 50, wherein the fiber comprises fiberglass.

54. The method of claim 50, wherein the fiber ranges in length from about 5 mm to about 100 mm.

55. The method of claim 50, wherein the fiber comprises a plurality of chopped fibers arranged in a non-structured, substantially random orientation.

56. The method of claim 50, further comprising applying a surface-active agent to at least a portion of the mixture dispersed onto the mold.

57. The method of claim 56, wherein the surface-active agent comprises at least one of a release agent or a barrier coating.

58. The method of claim 50, further comprising applying a surface-active agent to least one surface of the mold.

59. The method of claim 58, wherein the surface-active agent comprises at least one of a release agent, an in-mold coating or a barrier coating.

60. The method of claim 50, wherein the mold is shaped to form a substantially planar composite.

61. The method of claim 60, wherein the building structure comprises a door skin.

62. The method of claim 60, wherein the building structure comprises a panel.

63. The method of claim 50, wherein the building structure comprises cladding.

64. The method of claim 50, wherein the building structure comprises a door frame or a portion of a door frame.

65. The method of claim 50, wherein the building structure comprises a window frame part or a window part.

66. The method of claim 50, wherein the building structure comprises siding.

67. The method of claim 50, wherein the building structure comprises a shutter.

68. The method of claim 50, wherein the building structure comprises a shingle.

69. A method for producing a door skin comprising the steps of:
preparing a mold comprising a first and second die, where both dies comprise at least one substantially planar surface;
dispensing a mixture comprising a plurality of fibers and a polymer resin onto the substantially planar surface of the first die;
bringing the substantially planar surface of the second die in contact with the fibers and resin; and
allowing the resin to polymerize under conditions sufficient to produce a fiber-reinforced composite in the shape of a door skin.

70. The method of claim 69, wherein the polymer resin comprises a thermosetting polymer.

71. The method of claim 70, wherein the thermosetting polymer comprises polyurethane.

72. The method of claim 69, wherein the fiber comprises fiberglass.

73. The method of claim 69, wherein the fiber ranges in length from about 5 mm to about 100 mm.

74. The method of claim 69, wherein the fiber comprises a plurality of chopped fibers arranged in a non-structured, substantially random orientation.

75. The method of claim 69, further comprising applying a surface-active agent to at least a portion of the mixture dispensed onto the mold.

76. The method of claim 75, wherein the surface-active agent comprises a release agent or a barrier coating.

77. The method of claim 69, further comprising applying a surface-active agent to least one surface of the mold.

78. The method of claim 77, wherein the surface-active agent comprises at least one of a release agent, an in-mold coating or a barrier coating.

79. The method of claim 69, wherein at least one of the die surfaces in contact with the fibers and the polymer resin comprises a substantially flat surface such that the fiber-reinforced composite door skin comprises a flat profile.

80. The method of claim 69, wherein at least one of the die surfaces in contact with the fibers and the polymer resin comprises at least one of a groove or a protrusion such that the fiber-reinforced composite door skin comprises a molding.

81. The method of claim 69, wherein at least one of the die surfaces in contact with the fibers and polymer resin comprises a substantially smooth surface such that the fiber-reinforced composite door skin comprises at least one smooth surface.

82. The method of claim 69, wherein at least one of the die surfaces in contact with the fibers and polymer resin comprises a grain pattern such that the fiber-reinforced composite door skin comprises at least one surface having a grain pattern.

83. The method of claim 69, wherein the first die comprises a female die having a surface comprising at least one depression and the second die comprises a male die comprising at least one protrusion, such that when the mold is closed, the depression and the protrusion are aligned with each other.

84. The method of claim 69, wherein the dies are separated by a predetermined distance when the mold is closed.

85. The method of claim 84, wherein the predetermined distance ranges from 0.05 inches to 1.0 inch.

86. A system for manufacturing a building structure comprising an introducing apparatus and a mold shaped to form a building structure.

87. The system of claim 86, wherein the introducing apparatus comprises a mixer for mixing at least two separate components required to form a polymer resin.

88. The system of claim 86, further comprising at least two conduits for introducing the two separate resin components into the mixer.

89. The system of claim 86, further comprising a chopper for chopping a plurality of fibers to a predetermined length.

90. The system of claim 86, further comprising a dispenser for dispensing at least one of the fibers or the polymer resin onto a surface of the mold.

91. The system of claim 86, wherein the fiber comprises a plurality of chopped fibers arranged in a non-structured, substantially random orientation.

92. The system of claim 90, further comprising a robotic controller for positioning the dispenser at different positions relative to the mold.

93. The system of claim 86, further comprising a means for controlling the temperature of at least a portion of the mold.

94. The system of claim 86, wherein the polymer resin comprises a thermosetting polymer.

95. The system of claim 94, wherein the thermosetting polymer comprises polyurethane.

96. The system of claim 86, wherein the fiber comprises fiberglass.

97. The system of claim 96, wherein the fiberglass ranges in length from about 5 mm to about 100 mm.

98. The system of claim 86, wherein the building structure comprises a substantially planar structure.

99. The system structure of claim 98, wherein the building structure comprises a door skin.

100. The system of claim 99, wherein the mold comprises two dies shaped to press a door skin.

101. The system of claim 100, wherein the first die comprises a female die having a surface comprising at least one depression and the second die comprises a male die comprising at least one protrusion, such that when the mold is closed, the depression and the protrusion are aligned with each other.

102. The system of claim 100, wherein at least a portion of at least one of the two dies is polished to a smooth finish.

103. The system of claim 100, wherein at least a portion of at least one of the two dies comprises a pattern etched in the surface.

104. The system of claim 100, wherein the dies are separated by a predetermined distance when the mold is closed.

105. The system of claim 104, wherein the predetermined distance ranges from 0.05 inches to 1.0 inch.

106. The system of claim 86, wherein the building structure comprises a panel.

107. The system of claim 86, wherein the building structure comprises cladding.

108. The system of claim 86, wherein the building structure comprises a door frame or a portion of a door frame.

109. The system of claim 86, wherein the building structure comprises a window frame or a portion of a window.

110. The system of claim 86, wherein the building structure comprises siding.

111. The system of claim 86, wherein the building structure comprises a shutter.

112. The system of claim 86, wherein the building structure comprises a shingle.
